(19) United States
(12) Patent Application Publication
(10) Pub. No.: US 2006/0143099 A1
(43) Pub. Date: Jun. 29, 2006

(54) System, method, and computer program for creating and valuing financial insturments linked to average credit spreads

(76) Inventors: Daniel Partlow, Westport, CT (US); Kam Haq, New York, NY (US); Maria Mejevitch, Westport, CT (US); Sean O'Malley, New York, NY (US)

Correspondence Address: ROGER PITT;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 10/751,086

(22) Filed: Sep. 23, 2004

(51) Int. Cl. G06Q 40/00

(52) U.S. Cl. 705/35

(57) ABSTRACT

A system, method and computer program for creating and valuing financial instruments (including but not limited to futures, forwards, call options, put options, swaps, “swaptions”, and “op-swaps”) linked to average credit spread information. The present invention will be referred to in this application as an average credit spread-linked financial instrument, and is defined as a financial instrument whose value changes based on movements in underlying average credit spreads. These average credit spreads may be calculated, or may already be published by sovereign governments, government-chartered agencies and departments (ex. U.S. Treasury Department), non-governmental organizations, commercial banks, investment banks, and many other organizations. The instruments can be written, with a published average credit spread number as the initial value upon which the financial instrument's terms are based. The predicted future value of said credit spread will change in response to market buy/sell demand based on investor expectations of said predicted future value of said credit spread related to one or more credit spread-linked financial instrument(s). Thus, the predicted future value of said spread will change in response to said market demand as investors offer to buy and/or sell credit spread-linked financial instruments which will be listed on securities exchanges and electronic commerce networks (ECNs) as well as over the counter (OTC) and in private transactions. Each predicted future average credit spread value will change based on said investor expectation of how strong demand will be for the underlying average credit spread involved. Thus, the present invention gives investors a means of taking or adjusting positions upon average credit spread changes in market segments defined by geography, credit history, industry type, industry size, firm size, provision of collateral, third-party guarantee, or type of debt obligation. It is important to note credit spread-linked financial instruments can be created either in standardized contract sizes that can be traded on futures, options or other securities exchanges, ECNs and/or OTC, or can be customized to meet the specifications of a transactional counterparty which wishes to speculate on movements in market segments defined by geography, credit history, industry type, industry size, firm size, provision of collateral, third-party guarantee, or type of debt obligation. Such instruments may also be created from a plurality of spreads, thus allowing an investor to package movements from several different credit spreads into a single financial instrument. Such instruments may also involve a combination of credit spread-linked financial instruments, either with each other or with other financial instruments in a combination containing at least one credit spread-linked financial instrument.

### TECHNICAL FIELD

The present invention relates generally to financial trading systems and more particularly to the creation, identification, processing, trading, quotation, and valuation of average credit spread financial instruments such as derivatives and the like.

### BACKGROUND OF THE INVENTION

In today's financial markets, the use of financial instruments known as “derivatives” have exponentially grown and is now commonplace. A derivative is an investment vehicle whose value is based on the value of another security or underlying asset. That is, a derivative is essentially a financial instrument that is derived from the future movement of something that cannot be predicted with certainty. By the late 1990s the Office of the Comptroller of the Currency estimates that commercial banks in the United States alone held over twenty trillion dollars worth of derivative-based assets. Common examples of derivatives include futures contracts, forward contracts, options, and swaps, all of which are briefly explained below.

Derivatives are described in detail in a variety of publicly available documents, such as Morris, Kenneth, The Wall Street Journal's Guide To Understanding Money & Investing, Lightbulb Press and Dow Jones & Co. Inc., ISBN: 0684869020, which is incorporated herein by reference in its entirety.

Options contracts are agreements that may be exchange-traded among two parties. Options represent the right to buy or sell a specified amount of an underlying security (e.g. a stock, bond, spread, futures contract, etc.) at a specified price within a specified period of time. The parties of options contracts are buyers/purchasers/holders who acquire “rights,” and writers/sellers who assume “obligations.” Further, a “call” option contract is one giving the owner the right to buy at a specified price within a specified period of time, whereas a “put” option contract is one giving the owner the right to sell at a specified price within a specified period of time. There is typically an up-front, non-refundable premium that the buyer pays the seller to obtain the option rights. Note that for every option buyer there is an option seller. In other words, for every call buyer there is a call seller; for every put buyer, a put seller.

Forward and futures contracts are standardized, transferable agreements, which may be exchange-traded, to buy or sell a commodity (e.g. a particular crop, livestock, oil, gas, etc.). These contracts typically involve an agreed-upon place and time in the future between two parties, and lock in a price per unit at which delivery or settlement takes place.

Futures markets have been described as continuous auction markets and as clearing houses for the latest information about supply and demand. They are the meeting places of buyers and sellers of an ever-expanding list of commodities that today includes agricultural products, metals, petroleum, financial instruments, foreign currencies and stock spreads. As new supply and demand developments occur and as new and more current information becomes available, these judgments are reassessed and the price of a particular futures contract may be bid upward or downward. The process of reassessment—of price discovery—is continuous. There are two types of futures contracts, those that provide for physical delivery of a particular commodity or item and those which call for a cash settlement. The month during which delivery or settlement is to occur is specified. Thus, a July futures contract is one providing for delivery or settlement in July. In contrast, cash settlement futures contracts are precisely that, contracts which are settled in cash rather than by delivery at the time the contract expires. Stock spread futures contracts, for example, are settled in cash on the basis of the spread number at the close of the final day of trading. There is no provision for delivery of the shares of stock that make up the various spreads. Trading has also been initiated in options on futures contracts, enabling option buyers to participate in futures markets with known risks.

Swaps allow entities to exchange either variable cash flows for fixed payments, fixed cash flows for fixed payments, or variable cash flows for variable payments. They are similar to options but no premium (i.e., up-front money) is paid to obtain the rights. It is essentially an outright trade based on the expected movement of the price of the derivative's underlying commodity.

Options on futures contracts have added a new dimension to futures trading. Present-day options trading on the floor of an exchange began in April 1973 when the Chicago Board of Trade created the Chicago Board Options Exchange (CBOE) for the sole purpose of trading options on a limited number of New York Stock Exchange-listed equities. Options on futures contracts were introduced at the CBOT in October 1982 when the exchange began trading Options on U.S. Treasury Bond futures. An option, when purchased, gives the buyer the right (but not the obligation) to buy or sell a specific amount of a specific commodity at a specific price within a specific period of time. By comparison, a futures contract requires a buyer or seller to perform under the terms of the contract if an open position is not offset before expiration. Put and call options on futures contracts make it possible to speculate on increasing or decreasing futures prices with a known and limited risk. The most that the buyer of an option can lose is the cost of purchasing the option (known as the option “premium”) plus transaction costs.

The buyer of a call option acquires the right but not the obligation to purchase (“go long”) a particular futures contract at a specified price at any time during the life of the option. Each option specifies the futures contract which may be purchased (known as the “underlying” futures contract) and the price at which it can be purchased (known as the “exercise” or “strike” price). The most that an option buyer can lose is the option premium plus transaction costs. This will be the case if an option held until expiration is not worthwhile to exercise.

Whereas a call option conveys the right to purchase (“go long”) a particular futures contract at a specified price, a put option conveys the right to sell (“go short”) a particular futures contract at a specified price. Put options can be purchased to profit from an anticipated price decrease. As in the case of call options, the most that a put option buyer can lose, if he is wrong about the direction or timing of the price change, is the option premium plus transaction costs.

How Option Premiums are Determined

Option premiums are determined the same way futures prices are determined, through active competition between buyers and sellers. Three major variables influence the premium for a given option:
The option's exercise price, or more specifically, the relationship between the exercise price and the current price of the underlying futures contract, spread, etc. All else being equal, an option that already has intrinsic value because it is already worthwhile to exercise (known as an “in-the-money” option, where said underlying value is greater than the strike value for a call, or where said underlying value is less than the strike value for a put) commands a higher premium than an option that is not yet worthwhile to exercise (an “out-of-the-money” option, where said underlying value is less than the strike value for a call, or where said underlying value is greater than the strike value for a put). The more an option is in-the-money, the more it is worth
The length of time remaining until expiration. All else being equal, an option with a long period of time remaining until expiration commands a higher premium than an option with a short period of time remaining until expiration because it has more time in which to become profitable. Said another way, an option is an eroding asset. Its time value declines as it approaches expiration.
The volatility of the underlying futures contract. All else being equal, the greater the volatility the higher the option premium. In a volatile market, the option stands a greater chance of becoming profitable to exercise; thus, buyers pay more while writers demand higher premiums.

The price (value) of an option premium on a futures contract is determined competitively by open outcry auction on a trading floor (e.g. CBOT, NYME). The premium is affected by the influx of buy and sell orders reaching the exchange floor. An option buyer pays the premium in cash to the option seller. This cash payment is credited to the seller's account. Such price determination may just as easily occur on an electronic platform which processes incoming buy and sell orders, and it is the intention of many exchanges to migrate to this newer method of conducting trading operations.

Price Movements

Once a closing bell signals the end of a day's trading, the exchange's clearing organization matches each purchase made that day with its corresponding sale and tallies each member firm's gains or losses based on that day's price changes—a massive undertaking considering that nearly two-thirds of a million futures contracts are bought and sold on an average day. Each firm, in turn, calculates the gains and losses for each of its customers having futures contracts.

Gains and losses on futures contracts are not only calculated on a daily basis, they are credited and deducted on a daily basis. Thus, if a speculator were to have, say, a $300 profit as a result of the day's price changes, that amount would be immediately credited to his brokerage account and, unless required for other purposes, could be withdrawn. On the other hand, if the day's price changes had resulted in a $300 loss, his account would be immediately debited for that amount. This process is known as a daily cash settlement and is an important feature of futures trading. Because of margin requirements, it is the reason a party which incurs a loss on a futures position may be called on to deposit additional funds to its account.

The leverage of futures trading stems from the fact that only a relatively small amount of money (known as initial margin) is required to buy or sell a futures contract. On a particular day, a margin deposit of only $ 1,000 might enable an investor to buy or sell a futures contract covering $25,000 worth of soybeans. Or for $10,000, the investor might be able to purchase a futures contract covering common stocks worth $260,000. The smaller the margin in relation to the value of the futures contract, the greater the leverage. Leverage can produce either large profits in relation to initial margin, or large losses, depending on which way the price on the underlying futures contract changes. In this respect, leverage is a two-edged sword. For example, assume that in anticipation of rising stock prices an investor buys one June S&P 500 stock spread futures contract at a time when the June spread is trading at 1000 (assuming an initial margin requirement of $10,000). Since the value of the futures contract is $250 times the spread, each 1 point change in the spread represents a $250 gain or loss. Thus, an increase in the spread from 1000 to 1040 would double the $10,000 margin deposit and a decrease from 1000 to 960 would wipe it out. In this example, that's a 100% gain or loss as the result of only a 4% change in the stock spread. Leverage will have a similar impact on average credit spread futures contracts.

Average credit spread futures contacts will have both initial margin and maintenance margin. Initial margin (sometimes called original margin) is the sum of money that the customer must deposit with the brokerage firm for each futures contract to be bought or sold. Profits will accrue on open positions and losses will be deducted from the balance in the margin account. If and when the funds remaining available in the margin account are reduced by losses to below a certain level—known as the maintenance margin requirement—an additional deposit of funds will be required to bring the account back to the level of the initial margin. Such requests for additional margin are known as margin calls.

Derivatives are typically used by institutional investors to increase overall portfolio return or to manage portfolio risks. Derivatives are also frequently used by banks, companies, organizations, and the like to protect against market risks in general. For example, utility companies may be interested in protecting against meeting heating or cooling demands when unexpected weather occurs, and banks may be interested in protecting against the risk of loan defaults. Derivatives help in managing risks by allowing such banks, companies, organizations, and the like to divide their risk into several pieces that may be passed off to other entities that are willing to shoulder the risk for an up-front fee or future payment stream.

Derivatives, being a type of financial instrument, may be traded among investors as are stocks, bonds, and the like. Thus, in order to trade derivatives, there must be a mechanism to price them so that traders may exchange them in an open market.

The relationship between the value of a derivative and the underlying asset are not linear and can be very complex. Economists have developed pricing models to perform valuation of certain types of derivatives. As is well known in the relevant art(s), the Black-Scholes option pricing model is the most influential and extensively used pricing model. The Black-Scholes model is based on stochastic calculus and is described in detail in a variety of publicly available documents, such as Chriss, Neil A., The Black-Scholes and Beyond Interactive Toolkit: A Step-by-Step Guide to In-depth Option Pricing Models, McGraw-Hill, 1997, ISBN: 078631026X (USA), which is incorporated herein by reference in its entirety.

Whether using the Black-Scholes or any other pricing model, each has inherent flaws and thus poses risks. It has been estimated that some 40% of losses in dealing with derivatives can be traced to problems related to pricing models. Risks in relying on any model include errors in the model's underlying assumptions, errors in calculation when using the model, and failure to account for variables (i.e., occurrences) that may affect the underlying assets.

Average credit spreads, and more specifically future expected movement in such spreads, have not yet been an area of application for pricing models. The few models that have considered average credit spreads usually have only considered past (i.e., historical) average credit spread or spread data. Thus, regardless of the spread or instrument, risk management trading techniques or vehicles, traders essentially have been operating in the “blind” without knowledge of predicted future average credit spread movements.

### SUMMARY OF THE INVENTION

The present invention is a system, method, and computer program product for the creation, identification, processing, trading, quotation, and valuation of average credit spread financial instruments and/or financial instruments that are impacted in some manner by average credit spreads. The method preferably involves specifying a start date and maturity date for the financial instrument, and selecting at least one market segment (including but not limited to geography, credit history, industry type, industry size, firm size, provision of collateral, third-party guarantee, or type of debt obligation) to be covered by the financial instrument, and at least one currency denomination in which to represent the financial instrument. Then, at least one average credit spread that the financial instrument will derive its value from or is related to (or impacted by) is selected. Sources for average credit spread information include but are not limited to Bloomberg, Standard & Poor's, Moody's, Fitch, Reuters, Thomson Financial, the U.S. Treasury Department, and other global data sources. Average credit spread information may also be calculated in those instances where the information is not published by a data source or vendor, and may then still be used as part of the present invention. Credit spreads may be derived from credit data using methods including but not limited to:

The use of curve bootstrapping calculation models.

Historical bankruptcy and default data.

Expected default calculations, including those made possible by computer software.

Examination of bond valuation data.

Examination of CDS valuation.

Credit scores/ratings and future outlook published by rating agencies (ex. Moody's).

Public firm models versus private firm models.

The present invention's average credit spread data may be computed from credit spread information derived in any of the abovementioned methodologies. Other methodologies may be used as well.

The present invention combines Average credit spreads, financial instruments such as options, and pricing models to create a new class of financial instruments that are priced based on linkages to underlying average credit spread data.

In accordance with invention, average credit spread financial instruments allow buyers and sellers to speculate upon the movement of broad swaths of the global real estate market. Average credit spread financial instruments call for cash settlement rather than delivery of the underlying physical stock, commodity, or other asset type upon which said financial instruments may be based. Delivery-type futures contracts, for example, stipulate the specifications of the commodity to be delivered (such as 5,000 bushels of grain, 40,000 pounds of livestock, or 100 troy ounces of gold). Also, foreign currency futures provide for delivery of a specified number of euros, yen, pounds or pesos. U.S. Treasury obligation futures are in terms of instruments having a stated face value (such as $100,000 or $1 million) at maturity. In contrast, for example, financial instruments which call for cash settlement rather than delivery are based on a given spread number times a specified dollar multiple. This is the case, for example, with stock spread futures—and is also the case with the present invention since average credit spread financial instruments are linked by their very definition to underlying spreads. One possible mechanism for facilitating this form of settlement would be cashless exercise. Cashless exercise is a transaction used when exercising certain types of options. Essentially, the investor borrows enough money from his/her broker to exercise the options. The investor then simultaneously sells enough shares to pay for the purchase, taxes, and broker commissions. The investor is technically buying on margin. The brokerage lets the investor buy on margin in this case because the brokerage knows there will be a quick repayment. The advantage of this technique is that the investor does not need the cash on hand.

The present invention includes a systemic component that processes average credit spread information according to inputs. In the preferred embodiment of the present invention, a financial database may be accessed so that an interest rate or rates can be specified for use in pricing a financial instrument based upon an underlying average credit spread. An average credit spread history database and a predicted future average credit spread database are then accessed to obtain historic average credit spread information and the predicted future average credit spread information for the relevant market segment(s) during the period between the start date and the maturity date. A pricing model can then be applied to obtain a value for the average credit spread financial instrument using the historical average credit spread information, the predicted future average credit spread information, and the interest rate(s).

The system for the valuation of an average credit spread financial instrument of the present invention includes an average credit spread history database that stores historical average credit spread information for one or more spreads, and/or a predicted future average credit spread database that stores predicted future average credit spread information for said one or more spreads. The system may also include a financial database that stores information in order to calculate an interest rate(s). In order to access the databases and perform valuation of financial instruments, a trading server is included within the system. The trading server provides the central processing of the system by applying a pricing model, and is responsive to a plurality of internal and external workstations that allow users, via a graphical user interface, to access the trading system.

One advantage of the present invention is that the futures, options, swaps, and other derivative financial instruments which comprise the present invention can allow investors to trade on information related to how average credit spreads will trend in market segments defined by geography, credit history, industry type, industry size, firm size, provision of collateral, third-party guarantee, or type of debt obligation. In the preferred embodiment of the present invention, average credit spread financial instruments will call for a cash settlement rather than physical delivery, as physical delivery is not possible in the case of financial instruments that are linked to underlying credit spreads instead of physical commodities (such as oil or stock). As previously mentioned, one possible mechanism for facilitating this form of settlement would be cashless exercise. It is also a preferred embodiment of the present invention that buyers and sellers of average credit spread financial instruments may place their orders through a brokerage agent or trader to facilitate execution on a physical or electronic exchange.

Another advantage of the present invention is that information and data sets can be provided that enable traders to identify and capitalize on average credit spread-driven market fluctuations.

Further features and advantages of the invention as well as the structure and operation of various embodiments of the present invention are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements. Additionally, the left-most digit of a reference number identifies the drawing in which the reference number first appears.

FIG. 1 is a block diagram representing the system architecture of an embodiment of the present invention;

FIG. 2 depicts a preferred average credit spread history database which may be used by the present invention;

FIG. 3 depicts a preferred predicted future average credit spread database which may be used by the present invention;

FIG. 4 is a flowchart representing the preferred operation of the present invention;

FIG. 5 is an exemplary graphical user interface screen for the trading system of the present invention; and

FIG. 6 is a block diagram of an exemplary computer system useful for implementing the present invention.

### DETAILED DESCRIPTION OF THE PREFERRED EMBODIMENTS

A. Overview of Real Estate Index Linked Financial Instruments

1. A History of Credit Derivatives

The credit derivatives market has grown considerably over the previous five years. From almost nothing in 1995, total market notional now approaches $1 trillion (estimated). Growth in the market has taken place due to an increased understanding of the advantages that credit derivatives possess over cash-based alternatives, as well as recognition of the new opportunities presented by these instruments.

The primary purpose of credit derivatives is to enable the efficient transfer and repackaging of credit risk. The definition of credit risk encompasses all credit-related events ranging from a spread-widening, through a ratings downgrade, all the way to default. Banks in particular are using credit derivatives to hedge credit risk, reduce risk concentrations on their balance sheets, and free up regulatory capital in the process.

In their simplest form, credit derivatives provide a more efficient way to replicate in a derivative form the credit risks that would otherwise exist in a standard cash instrument. For example, a standard credit default swap can be replicated using a cash bond and the repo market.

In their more exotic form, credit derivatives enable the credit profile of a particular asset or group of assets to be split up and redistributed into a more concentrated or diluted form that appeals to the various risk appetites of investors. The best example of this is the tranched portfolio default swap. With this instrument, yield-seeking investors can leverage their credit risk and return by buying first-loss products. More risk-averse investors can then buy lower-risk, lower-return second-loss products.

With the introduction of unfunded products, credit derivatives have for the first time separated the issue of funding from credit. This has made the credit markets more accessible to those with high funding costs and made it cheaper to leverage credit risk.

Recognized as the most widely used and flexible framework for over-the-counter (OTC) derivatives, the documentation used in most credit derivative transactions is based on the documents and definitions provided by the International Swaps and Derivatives Association (ISDA). The key features of these definitions will be discussed in a later section of this document.

Much of the growth in the credit derivatives market has been aided by the growing use of the LIBOR swap curve as an interest rate benchmark. As it represents the rate at which AA-rated commercial banks can borrow in the capital markets, it reflects the credit quality of the banking sector and the cost at which they can hedge their credit risks. It is, therefore, a pricing benchmark. It is also devoid of the idiosyncratic structural and supply factors that have distorted the shapes of the government bond yield curves in a number of important markets.

Bank capital adequacy requirements play a major role in the credit derivatives market. The fact that the participation of banks accounts for over 50% of the market's outstanding notional means that an understanding of the regulatory treatment of credit derivatives is vital to understanding the market's dynamics. The 1988 Basel Accord, which set the basic framework for regulatory capital, predates the advent of the credit derivatives market. Consequently, it does not take into account the new opportunities for shorting credit that have been created and are now widely used by banks for optimizing their regulatory capital. As a consequence, individual regulators have only recently begun to formalize their own treatments for credit derivatives, with many yet to report.

A major review of the bank capital adequacy framework is currently in progress: a consultative document was published approximately three years ago by the Basel Committee on Banking Supervision.

Investment restrictions prevent many potential investors from participating in the credit derivatives market. However, a number of repackaging vehicles exist that can be used to create securities that satisfy many of these restrictions and open up the credit derivatives market to a wider range of investors.

In some senses, the terminology of the credit derivatives market can be ambiguous to the uninitiated since buying a credit derivative usually means buying credit protection, which is economically equivalent to shorting the credit risk. Equally, selling the credit derivative usually means selling credit protection, which is economically equivalent to going long the credit risk. One must be careful to state whether it is credit protection or credit risk that is being bought or sold. An alternative terminology is to talk of the protection buyer/seller in terms of being the payer/receiver of premium.

Over the past 18 months, the credit derivatives market has seen the arrival of electronic trading platforms such as CreditTrade and CreditEx.

In January 2001, a survey by Risk Magazine estimated the size of the credit derivatives market at year-end 2000 to be around $810 billion. This number was determined by polling dealers who were estimated to account for about 80% of the total market.

These reports show that the size of the credit derivatives market has increased at a phenomenal pace, with an annual growth rate of over 50%. It is estimated in a survey by the BBA (British Bankers' Association) in their Credit Derivatives Report (2000) that the market would achieve a size close to $1.5 trillion by the end of 2001. To put this into context, the total size of all outstanding dollar denominated corporate, utility, and financial sector bond issues is around $4 trillion.

Market Breadth

In terms of the credits actively traded, the credit derivative market spans across banks, corporates, high-grade sovereign and emerging market sovereign debt. Recent estimates show corporates account for just over 50% of the market, with the remainder split roughly equally between banks and sovereign credits.

The 2001 survey by Risk Magazine provides a more detailed graphical breakdown. It reported that 41% of default swaps are linked to U.S. credits, 38% to European credits, 13% to Asian, and 8% to non-Asian emerging markets.

A 1998 survey by Prebon Yamane of all transactions carried out in 1997 reported that 93% of those referenced to Asian issuers were to sovereigns. In contrast, 60% of those referenced to U.S. issuers were to corporates, with the remainder split between banks (30%) and sovereigns (10%). Those referenced to European issuers were more evenly split, with sovereigns accounting for 45%, banks 29%, and corporates 26%.

Clearly, the credit derivative market is not restricted to any one subset of the credit markets. Indeed, it is the ability of the credit derivative market to do anything the cash market can do and potentially more that is one of its key strengths. For example, it is possible to structure credit derivatives linked to the credit quality of companies with no tradeable debt. Companies with exposure to such credits can use this flexibility to hedge their exposures, while investors can diversify by taking exposure to new credits that do not exist in a cash format.

Participants

Historically, banks have dominated the market as the biggest hedgers, buyers and traders of credit risk.

A Breakdown of Who Buys and Sells Protection by Market Share at the Start of 2000

| Counterparty | Protection Buyer (%) | Protection Seller (%) |
|---|---|---|
| Banks | 63% | 47% |
| Securities Firms | 18% | 16% |
| Insurance Companies | 7% | 23% |
| Corporations | 6% | 3% |
| Hedge Funds | 3% | 5% |
| Mutual Funds | 1% | 2% |
| Pension Funds | 1% | 3% |
| Government/Export | 1% | 1% |
| Credit Agencies | | |

Source: British Bankers' Association Credit Derivatives Report 2000

As in its earlier 1998 survey, the BBA found that banks easily dominate the credit derivatives market as both buyers and sellers of credit protection. Since banks are in the business of lending and thereby taking on credit exposure to borrowers, it is not surprising that they use the credit derivatives market to buy credit protection to reduce their exposure.

Though the precise details may vary between different regulatory jurisdictions, banks can use credit derivatives to offset and reduce regulatory capital requirements. On a single asset level, this may be achieved using a standard default swap. More commonly, banks are now using credit derivatives to securitize whole portfolios of bonds and loans. In doing so, banks can reduce regulatory capital, reduce credit risk concentrations, and enhance return on capital. The 2001 Risk Magazine survey finds that banks as counterparties in synthetic securitizations account for 18% of the market.

At the same time, banks are also seeking to maximize return on equity, and credit derivatives provide an unfunded way for banks to earn yield from their under-used credit lines and to diversify concentrations of credit risk. As a consequence, banks are the largest sellers of credit protection.

Securities firms are the second-most dominant player in the market. With their market making and risk-taking activities, securities firms are a major provider of liquidity to the market. As they tend to run a flat trading book, they become buyers and sellers of protection in approximately equal proportions.

An interesting development in the credit derivatives market has been the increased activity of insurance and re-insurance companies, on both the asset and liability side. For insurance companies, selling protection using credit derivatives presents a new asset class that can be used to earn income and diversify revenue away from their core business of insurance. The credit derivatives market is ideal for this since through the structuring of second-loss products, it creates the very highly rated securities that insurance companies require in order to maintain their high ratings. As compensation for their novelty and lower liquidity compared with Treasury bonds, these securities can return a substantially higher yield for a similar credit rating. On the liability side, re-insurance companies are also prepared to take leveraged credit risks, such as retaining the most subordinate piece on tranched credit portfolios. This is seen as just another way to write insurance contracts.

As protection buyers, this growth in usage by insurance companies has been driven by their desire to hedge various insurance risks. For instance, in the area of insuring project financing within developing economies, the sovereign credit derivatives market provides a good, though imperfect, hedge against any sovereign risk to which they may be exposed. Re-insurance companies who typically develop concentrations of credit risk can use credit derivatives to reduce this exposure and so enable them to take on new more diversified business without an overall increase in risk. Over the next few years, insurance companies may come to account for an ever larger share of the credit derivatives market.

Hedge funds are another growing participant. Some focus on exploiting the arbitrage opportunities that can arise between the cash and default swap markets. Others focus on portfolio trades such as investing in CDOs (collateralized debt obligations). Equity hedge funds are especially involved in the callable asset swap market in which convertible bonds have their equity and credit components stripped. These all add risk-taking capacity and thus add to market liquidity.

Products

There are a number of different products that may be classified as credit derivatives, ranging from the simple asset swap to the synthetic CLO (collateralized loan obligations). The table below shows the market share (as a percent of market notional) of the different credit derivative instruments as reported by the BBA for the start of 2000.

Market Share of Outstanding Notional for Credit Derivative Products

| | Market Share (% Notional) |
|---|---|
| Credit Derivative Instrument Type | at End 1999 |
| Credit Default Products | 38% |
| Portfolio/CLOs | 18% |
| Asset Swaps | 12% |
| Total Return Swaps | 11% |
| Credit Linked Notes | 10% |
| Baskets | 6% |
| Credit Spread Products | 5% |

Source: British Bankers' Association Credit Derivatives Report 2000

Another new entrant is the default basket. This is also a portfolio credit product that introduces a new way for investors to leverage their credit risk and earn yield. Though it constitutes only 6% of the outstanding market notional, this percentage is expected to increase over the next few years. The default basket is unique in the sense that it is the simplest credit derivative that allows investors to trade default correlation.

As these results have shown, the credit derivative market has evolved rapidly over the last five years in terms of increasing its size, broadening its base of participants, and expanding its list of products. The market has achieved critical mass and has become an effective and efficient way to commoditize credit risk. The market is also converging rapidly towards standardized products, especially for the credit default swap. With the increased participation of the newer players such as insurance, re-insurance companies, and hedge funds, further evolution and growth as well as increased liquidity are expected in the worldwide credit derivatives market.

2. How the inventive Average Credit Spread Financial Instruments Are Created and Used

The present invention allows the creation, identification, processing, trading, quotation, and valuation of an inventive of-financial instrument which is an average credit spread financial instrument. The inventive average credit spread financial instrument is a contract whose value is based on average credit spreads in market segments defined by geography, credit history, industry type, industry size, firm size, provision of collateral, third-party guarantee, or type of debt obligation. The inventive average credit spread financial instruments may be utilized, by way of example, by buyers of Ford's debt wishing to hedge exposure to Ford's credit quality by diversifying that credit exposure into a general “Big Three” automaker exposure to Ford, General Motors, and DaimlerChrysler, the three major U.S. automakers. To continue the example, said buyers may be concerned with growing pension obligations and foreign competition for the Big Three automakers, and may wish to buy call options based on an average credit spread for the automotive industry in order to hedge against the risk of an increase in average credit spreads for the “Big Three” in the U.S. automotive assembly industry. Settlement of such contracts may involve initial margin/good faith deposits to allow buyers to employ leverage at the time of purchase and thus put down less cash than the face value of the contract at the time of purchase. The settlement transactions could take place based on each day's closing price of the instrument in question.

The inventive average credit spread futures contract (a subset of average credit spread financial instruments) is designed to trade either on an exchange or system (either open-outcry or electronic), an ECN (electronic commerce system), an over-the-counter system (OTC). Forward and futures contracts are standardized, transferable agreements, which may be exchange-traded, to buy or sell a commodity (e.g. a particular crop, livestock, oil, gas, etc.). These contracts typically involve an agreed-upon place and time in the future between two parties.

The inventive average credit spread options contracts are also a subset of average credit spread financial instruments. Typically, options contracts are agreements that may be exchange-traded among two parties. Options represent the right to buy or sell a specified amount of an, underlying security (e.g. a stock, bond, futures contract, etc.) at a specified price within a specified time. The parties of options contracts are purchasers who acquire “rights,” and sellers who assume “obligations.” Further, a “call” option contract is one giving the owner the right to buy, whereas a “put” option contract is one giving the owner the right to sell the underlying security. There is typically an up-front, non-refundable premium that the buyer pays the seller to obtain the option rights. With regards to an average credit spread options contract, there is no underlying security, but rather an underlying spread value tied to average credit spread performance in a particular market segment(s) defined by geography, credit history, industry type, industry size, firm size, provision of collateral, third-party guarantee, or type of debt obligation.

The pricing of an option of an asset is a fundamental problem of significant practical importance in today's financial markets. In 1973, a mathematician, Fischer Black, and an economist, Myron Scholes, devised one of the first mathematically accepted approaches for pricing what is known as a “European” option, which are options that can only be exercised at its expiration date. What has become known as the Black-Scholes option formula was described first in “The pricing of options and corporate liabilities,” Journal of Political Economy 81 (1973), which is incorporated herein by reference in its entirety. The Black-Scholes option formula is presently of widespread use in financial markets all over the world. The price of such an option can be found by solving the Black-Scholes equation with the initial condition at expiration (i.e., the payoff of the option). The Black-Scholes equation is a reverse diffusion equation with parameters determined by the statistical characteristics of involved stocks and currencies such as risk free interest rate, holding cost or expected dividends, and volatility.

As an example, the Black-Scholes formula for the theoretical price of a vanilla European call option is:
C=S*N(d₁)−Ke^{-(rt)}*N(d₂) (1)
where the notation is fairly standard, as described by P. Wilmott, J. N. Dewynne and S. Howison, “Option Pricing: Mathematical Models and Computation”, Oxford Financial Press, Oxford (1993).

However, in the case of American options, the above formula (1) and its analogs are no longer valid. In fact, as shown in a paper of P. Jaillet, D. Lamberton, and B. Lapeyre, “Variational inequalities and the pricing of American options,” Acta Applicandae Mathematicae 21 (1990) 263-289, a rigorous mathematical model for pricing an American option is an infinite-dimensional free boundary problem, which paper is incorporated herein by reference in its entirety. As such, there is in general no explicit formula or finite procedure for computing the exact price of an American option. As a result, various mathematical models have been devised in an attempt to approximate the price of such options.

The option prices computed from a mathematical model are of a theoretical nature. In computing these prices, various inputs are fed into the model and an algorithm produces an answer. In practice, the computed prices may not be consistent with the observed market prices, e.g., the prices on the trading floor. Ideally, these two sets of prices should coincide. However, such a result is difficult, if not impossible, using known models. Two principal reasons for this are: (i) the assumptions that lead to the construction of the mathematical model may not be realistic; and (ii) the inputs to the model are not correct. In particular, using an incorrect volatility parameter in the forward option pricing model means that the computed option price is bound to deviate, often substantially, from the option price observed on the trading exchange, either physical or electronic.

Previous approaches for dealing with this difficult problem of unknown volatility are numerous and include: (i) statistical estimation methods based on historical data (such as J. Hull, Options, Futures, and Other Derivative Securities, Second Edition, Prentice Hall, New Jersey (1989), Section 10.4 and R. Gibson, Option Valuation: Analyzing and Pricing Standardized Option Contracts, McGraw-Hill, New York (1991), Section 1; (ii) mathematical models of stochastic volatilities such as those in J. Hull and A. White, “The pricing of options on assets with stochastic volatilities,” The Journal of Finance 42 (1987) 281-300; H. Johnson and D. Shanno, “Option pricing when the variance is changing,” Journal of Financial and Quantitative Analysis 22 (1987) 143-151; and (iii) implied volatilities based on observed option prices (suggested originally by H. A. Latant and R. J. Rendleman, “Standard deviations of stock price ratios implied in option prices,” The Journal of Finance 31 (1976) 369-381 and empirically tested by S. Beckers, “Standard deviation implied in option prices as predictors of future stock price volatility” Journal of Banking and Finance 5 (1981) 363-381). All of these works are incorporated herein by reference in their entirety.

3. Overview of the Present Invention

Fixed coupon bonds issued in the United States are typically done so on the basis of a ‘credit spread’—represented by the number of basis points (each basis point equals 1/100^{th} of a percent) over the yield of the comparable maturity risk-free Treasury bill, note or bond. This ‘credit spread’ reflects the incremental return required by the marketplace to compensate for the riskiness of the bond. The credit spread for a bond will vary based primarily on factors such as credit rating of the issuer, industry segment of the issuer, maturity date of the bond, currency of issue, and type of debt obligation.

An average credit spread financial instrument combined several credit spreads from different sources, such as from all firms within an industry. The advantage of the present invention is that the buyer of the average credit spread financial instrument has now diversified his or her exposure to any single credit spread. For example, take the case of an investor which has an exposure to Ford's debt over the course of 2003. As Ford's financial condition has deteriorated, the firm's credit spread over U.S. Treasury bonds has widened. Thus, an investor would have been less exposed to widening credit spreads for Ford's debt over the course of 2003 if the investor held an average credit spread financial instrument which combined credit spreads from Ford, General Motors, and DaimlerChrysler into a diversified average number. The average credit spread is less susceptible to movements linked to a single firm in the average, simply because it is an average.

An average credit spread financial instrument may be an option, option on futures, futures or forward contract, swaption, op-swap, or swap, where the value of the product should reflect the average credit spread over the currency-appropriate risk-free interest rate of similar tenor. For example, in the case of a futures contract on fair market credit spreads, the futures should pay off so that the futures contract holder will receive a cash amount equivalent to the spread over some notional amount (e.g. if the credit spread was 100 bps. on a notional of $1 million with a semi-annual coupon, then the payoff should be $5,000).

Average credit spread financial instruments may be segmented by the following:
Geography (ex. U.S., Japan, European Union)
Credit rating of the issuer—Typically rated by S&P, Moody's, Fitch, etc., and could be, for example, AAA, AA(−), A(±), BBB(±), BB(±), B(±), and other rating/outlook values. Credit ratings may also be of different types—for example, “Short-Term” or “Long-Term”. Finally, credit ratings may be applicable towards either Securities or Issuers/Entities. For example, there are Long-Term Debt ratings that are applicable towards a class of securities (in this case, a company's long-term debt) while other ratings may be applicable towards all securities/issues that have been issued by an issuer or entity. For credit rating, it is also an embodiment of the present invention that historical credit rating information may also be used.
Industry segment—for example, Industrials, Banks, Telecommunications, Finance, Utilities, or Transportation. It is also an embodiment of the present invention that Composites may be used in the case where a credit spread-linked financial instrument is based upon credit spreads from more than one industry segment. It is also an embodiment of the present invention that industry segments may be further segmented according to size. Said size may be defined in terms of market capitalization, sales, assets, liabilities, return on assets, return on equity, PPE (plant, property & equipment), inventory, and/or number of employees. Size may also be considered in relative terms within an industry segment, e.g. “the five largest Japanese banks by assets” or “the ten largest European airlines”.
Maturity date of the financial instrument—Note that some credit spread-linked notes may not have a maturity date, but instead may pay out a coupon in perpetuity while never paying out the principal.
Currency of Issue—for example, the U.S. Dollar (“USD”), Japanese Yen (“JPY”), Great Britain Pound (“GBP”), Canadian Dollar (“CAN”), or a supra-national currency such as the Euro (“EUR”).
Type of debt obligation—for example, MTN, Underwritten, Global, or Yankee.
Provision of collateral and/or third-party guarantee(s).

Some financial data sources will aggregate such credit spread data and segment it by credit rating, industry segment and maturity date. The information will be reported in the following format—the AA-Bank 5-year credit spread is 32 basis points over the 5-year Treasury note. Bloomberg, for example, has a large listing of such data in their Fair Market Yield Curves.

Using this existing type of data, the present invention may be created. The present invention is a new class of financial instruments based upon average credit spreads. The class of financial instruments includes, but is not limited, to the following:

Options on Average Credit Spread Futures Contracts

These are options that will have their value determined by the dependence on an underlying average credit spread futures contract.

Average Credit Spread Call Option on Futures Contract: This call option on a futures contract is an option where the purchaser has the right, but not the obligation, to buy the underlying security from the writer/seller of the option during a defined period of time at a fixed price wherein the underlying security is an average credit spread futures contract. Settlement could require the exchange of the entire transaction value between the buyer and writer/seller, or exchange of the prevailing market price for the underlying security less the strike “price” or spread value of the option.

Average Credit Spread Put Option on Futures Contract: This put option on a futures contract is an option where the purchaser has the right, but not the obligation, to sell the underlying security to the writer/seller of the option during a defined period of time at a fixed price wherein the underlying security is an average credit spread futures contract. Settlement could require the exchange of the entire transaction value between the buyer and writer/seller, or exchange of the strike price or spread value of the option less the prevailing market price for the underlying security.

Average Credit Spread Options

Average Credit Spread American Option: An option that can be exercised anytime during its life. The majority of exchange-traded options are American style. The name has nothing to do with geographic location.

Average Credit Spread Asian Option: An option whose payoff depends on the average price of the underlying asset over a certain period of time. These types of option contracts are attractive because they tend to cost less than regular American options. Also known as an ‘average option’.

Average Credit Spread Asset-or-Nothing Call Option: An option payoff that is equal to the asset's price if the asset is above the strike price, otherwise the payoff is zero.

Average Credit Spread Asset-or-Nothing Put Option: An option payoff that is equal to the asset's price if the asset is below the strike price, otherwise the payoff is zero.

Average Price Call: A type of option where the payoff is either zero or the amount by which the average credit spread value exceeds the strike.

Average Price Put: A type of option where the payoff is either zero or the amount by which the strike price exceeds the average credit spread value.

Average Credit Spread Balloon Option: An option for which the notional payments increase significantly after a set threshold is broken. Commonly used in foreign exchange markets, these options provide for greater leverage to the holder. The main idea behind the balloon option is that after the threshold is exceeded, the regular payout is increased. For example, assume that the threshold is $100. After the underlying exceeds this amount, rather than paying the regular dollar-for-dollar amount, the option payment would balloon to two dollars for every one-dollar change against the strike price.

Average Credit Spread Barrier Option: A type of option where the payoff depends on whether or not the underlying asset has reached or exceeded a predetermined price. A barrier option is a type of exotic option. Barrier options can be either knock-ins or knock-outs.

Average Credit Spread Basket Option: A type of option where the underlying value is a basket of average credit spreads. This allows the buyer/holder to speculate upon a group of average credit spreads with various weightings in the basket. For example, a buyer could purchase an average credit spread basket option from a seller that is weighted accordingly: 30% of an average credit spread for U.S. construction companies with market capitalization greater than $1 billion, 30% of an average credit spread on the credit ratings between Disney's 30-year bond over the U.S. Treasury's 30-year bond, 20% of an average credit spread on Japanese banks as a whole, 10% of an average credit spread across the entire market in both the United Kingdom and Ireland, 5% of an average credit spread for senior long-term debt issued by U.S. banks but denominated in Mexican pesos, and 5% to an average credit spread for Canadian debentures maturing in January 2023. As will be apparent to those skilled in the art, average credit spread basket options may be constructed across millions of permutations involving the selection of:
1.) a different spread, spreads, or types of spreads.
2.) different weightings per spread, spreads or type of spread
3.) different pay-in and/or payout currencies per weighting per spread, spreads, or type of spread
4.) different triggers that may affect weightings at points in time for each spread, spreads, or types of spreads
5.) differing option specifications and/or types per spread, spreads, or types of spreads. For example, an average credit spread basket option could be created with a call-type option (American exercise) on a 50% weighting in a U.S. airline average credit spread, a put-type option (Bermuda exercise) on a 30% weighting in a French transportation sector average credit spread, and a chooser-type option on a 20% weighting in an average credit spread for large-cap Canadian manufacturing firms.
6.) different swaps and/or swap “legs” linked to each spread, spreads or types of spreads comprising an average credit spread basket option
7.) different swaptions linked to each spread, spreads, or types of spreads comprising an average credit spread basket option
8.) different commodities linked to each spread, spreads, or types of spreads comprising an average credit spread basket option
9.) different forwards linked to each spread, spreads, or types of spreads comprising an average credit spread basket option
10.) different futures linked to each spread, spreads, or types of spreads comprising an average credit spread basket option
11.) different caps linked to each spread, spreads, or types of spreads comprising an average credit spread basket option
12.) different floors linked to each spread, spreads, or types of spreads comprising an average credit spread basket option
13.) different collars linked to each spread, spreads, or types of spreads comprising an average credit spread basket option
14.) different corridors linked to each spread, spreads, or types of spreads comprising an average credit spread basket option
15.) different average credit spread notes linked to each spread, spreads, or types of spreads comprising an average credit spread basket option
16.) different financial guarantees (including provision of collateral and/or third-party guarantee) linked to each spread, spreads, or types of spreads comprising an average credit spread basket option
17.) different fixed-income instruments linked to each spread, spreads, or types of spreads comprising an average credit spread basket option
18.) different fixed-income spreads linked to each spread, spreads, or types of spreads comprising an average credit spread basket option
19.) different equities linked to each spread, spreads, or types of spreads comprising an average credit spread basket option,
20.) different equity spreads linked to each spread, spreads, or types of spreads comprising an average credit spread basket option
21.) different commodity spreads linked to each spread, spreads, or types of spreads comprising an average credit spread basket option
22.) different futures spreads linked to each spread, spreads, or types of spreads comprising an average credit spread basket option
23.) different forwards spreads linked to each spread, spreads, or types of spreads comprising an average credit spread basket option
24.) different swap spreads linked to each spread, spreads, or types of spreads comprising an average credit spread basket option
25.) different option spreads linked to each spread, spreads, or types of spreads comprising an average credit spread basket option

As a result of the component of the present invention known as average credit spread basket options, investors may now construct investment positions that can benefit almost any portfolio strategy involving a market segment(s) defined by geography, credit history, industry type, industry size, firm size, provision of collateral, third-party guarantee, or type of debt obligation.

As will be apparent to those skilled in the relevant arts, the above example and detailed list of permutations should in no way be construed to limit the spirit and scope of the present invention, which allows a vast array of arbitrage possibilities for investors and speculators to explore with the creation of average credit spread financial instruments.

Average Credit Spread Bermuda Option: A type of option that can only be exercised on predetermined dates, usually every month. “Bermudas” are a combination of American and European style options.

Average Credit Spread Call Option: A call option where the purchaser has the right, but not the obligation, to buy a value as a strike price in the underlying spread from the writer/seller of the contract during a defined period of time at a fixed price, wherein the underlying spread is an average credit spread with numerical values published at regular time intervals. The buyer profits on a call when the underlying spread increases in value above the purchased value or strike price of the option. A premium is paid by the investor/buyer/holder of the option to the writer/seller of the option for this right. Settlement could require the exchange of the entire transaction value between the buyer and writer/seller, or the exchange of the prevailing market spread value of the underlying average credit spread less the strike price or spread value of the contract, times a cash multiple.

Average Credit Spread Capped Option: An option with a pre-established profit cap. A capped option is automatically exercised when the underlying security closes at or above (for a call) or at or below (for a put) the Option's cap price. This can also be referred to as a capped-style option.

Average Credit Spread Cash-or-Nothing Call: A type of option whose payoff is set to a specified fixed price if the final asset price is above the strike price; if not, the payoff is set to zero.

Average Credit Spread Cash-or-Nothing Put: A type of option whose payoff is set to a specified fixed price if the final asset price is below the strike price; if not, the payoff is set to zero.

Average Credit Spread Chameleon Option: An option that has the ability to change its structure, should certain pre-determined terms of the contract be met. An example of a chameleon option would be a put option that automatically changes into an identical call option after the price of the underlying exceeds a certain price. This is similar to a long or short straddle except investors are not required to open two positions.

Average Credit Spread Chooser Option: An option where the investor has the opportunity to choose whether the option is a put or call at a certain point in time during the life of the option. Also known as ‘hermaphrodite option’ or ‘AC-DC option’.

Average Credit Spread Cliquet: An extended option that periodically settles and resets its strike price at the level of the underlying during the time of settlement. For example, a 3 year cliquet option with a strike of 1000 would expire worthless on the first year if the underlying was to be 900. This value would then be the new strike for the following year and should the underlying on settlement be 1200, the contract holder would receive a payout and the strike would reset to this new level. Higher volatility provides better conditions for investors to earn profits. Also known as a ‘ratchet option’ or ‘cliquet option’.

Average Credit Spread Compound Option: An option on an option. Examples include a call on a call, a put on a put, a call on a put, and a put on a call. This type of option usually exists for currency or fixed income markets where an uncertainty exists regarding the option's risk protection capabilities. Also known as a split-fee option.

Average Credit Spread Contingent Option: An option for which the holder only pays the premium if the option is exercised. Contingent options are, therefore, a zero-cost option strategy, unless exercised.

Average Credit Spread Digital Option: An option whose payout is fixed after the underlying stock exceeds the predetermined threshold or strike price. The value of the payout is determined at the onset of the contract and doesn't depend on the magnitude by which the underlying spread's price moves. So, should the investor be in the money by $1 or $5, the amount that the investor will receive will be the same. These options are also referred to as binary or all-or-nothing options.

Average Credit Spread Double Barrier Option: An option with two distinct triggers that define the allowable range for the price fluctuation of the underlying asset. In order for the investor to receive a payout, one of two situations must occur; the price must reach the range limits (for a knock-in) or the price must avoid touching either limit (for a knock-out). A double barrier option is a combination of two dependent knock-in or knock-out options. If one of the barriers is reached in a double knock-out option, the option is killed. If one of the barriers is reached in a double knock-in option, the option comes alive.

Average Credit Spread Double No-Touch Option: An option with two distinct triggers that define the allowable range for the price fluctuation of the underlying asset. The double no-touch option pays a fixed amount if the spot price never touches either of the two specified limits (barrier levels). Factors that must be specified are the desired payoff, the currency pair, the barrier price, and the expiration date. As long as the spot level never hits the two barrier levels, the buyer/holder receives the payoff amount at expiry. If the barrier is reached during the option period, the option expires worthless. An example of a double no-touch option is the following:

| Currency: | USD/JPY |
|---|---|
| Barrier Price #1: | 116 |
| Barrier Price #2: | 124 |
| Current Spot Level: | 121 |
| Expiration Date: | 2 months from today |
| Payoff: | $7,000 |
| Cost: | $1,500 |
| Net profit if barrier is reached: | $5,500 |

If the spot value never reaches either barrier prior to expiry, then this option is profitable for the buyer. If the spot value reaches either barrier prior to expiry, then there is no payoff at expiry, and therefore this option is unprofitable for the buyer.

Average Credit Spread Down-and-In Option: An option that comes into existence when the price of an underlying security sinks to a specified level.

Average Credit Spread Down-and-Out Option: An option that ceases to exist when the price of an underlying security sinks to a specified level.

Average Credit Spread Embedded Option: An option that is an inseparable part of another instrument. Compare this to a normal (or bare) option, which trades separately from the underlying security. A common embedded option is the call provision in many corporate bonds.

Average Credit Spread Employee Stock Option: Stock options granted to specified employees of a company. ESOs carry the right, but not the obligation, to buy a certain amount of shares in the company at a predetermined price. ESOs are slightly different from regular options, because they do not have puts and the holder typically must wait a specified period before he/she/it is allowed to exercise the option. An Employee Stock Ownership Plan (ESOP) is an organized plan for the employees of a company to buy shares of its stock (also known as a stock purchase plan).

Average Credit Spread Foreign Exchange Option (ELF-X): A put or call option that protects an investor from foreign exchange risk for a future sale or purchase of a specified foreign equity portfolio. ELF-X options are a combination of a currency option and an equity forward contract. Should the exchange rate work in the investor's favor under the option contract, the total payout received from the option is dependent upon the performance of the equities underlying the contract. Otherwise, the investor does not receive a payout. For example, if an investor holds an ELF-X call option on USD relative to CAD, and the Canadian dollar depreciates relative to the American, the investor would not receive a payout. However, if USD depreciated relative to CAD, the investor would receive the amount saved from use of the spot exchange rate in the option contract and the foreign equity portfolio value, less the premium paid for the call option. Also known as a “portfolio currency protection option” or PCPO.

Average Credit Spread European Option: An option that can only be exercised at the end of its life. In other words, the holder must wait until the maturity date to exercise.

Average Credit Spread Evergreen Option: An employee option plan that grants additional shares to the plan every year. The number of shares granted to the plan is determined by a set percentage of the company's common shares outstanding. In most cases, these plans don't have an expiry date and do not require shareholder approval. Also known as an evergreen plan.

Average Credit Spread Exotic Option: Any non-standard option. This is the opposite of a “plain vanilla option.”

Average Credit Spread Flexible Exchange Option (FLEX): An option, generally written by clearing houses, that can be modified regarding expiration dates, strike prices, or exercising styles. Flex options provide flexibility to investors, as they can be tailored to meet their specific needs.

Average Credit Spread Incentive Stock Option (ISO): A type of employee stock option with a tax benefit, when the holder exercises, of not having to pay ordinary income tax. Instead, the options are taxed at a capital gains rate. Although ISOs have more favorable tax treatment than NSOs, they also require the holder to take on more risk by having to hold onto the stock for a longer period of time in order to receive the better tax treatment. Additionally, there are numerous restrictions which have to be met in order to qualify as an ISO.

Average Credit Spread Jump Option: An option which is priced using a jump-diffusion process.

Average Credit Spread Knock-in Option: An option which ‘knocks-in’ or begins to function as a normal option once a certain price level is reached before expiration. Knock-ins are a type of barrier option that may be either ‘down and in’ or ‘up and in.’

Average Credit Spread Knock-out Option: An option with a built in mechanism to expire worthless should a specified price level be exceeded.

Average Credit Spread Ladder Option or Note: An spread or currency option or spread-linked note that provides an upward reset of its minimum payout when the underlying touches or trades through certain steps or threshold levels or attains a certain level on designated reset dates. For example, if the underlying trades through a price 35 percent above the strike, the holder of the instrument may be guaranteed a minimum payout equal to the value of the instrument at that price even if the spread subsequently declines. A series of steps can ratchet the minimum payout up the ladder, providing protection from a later decline in the spread. Also called Lock-Step Option, Step-Lock Option or Note, Cliquet Option, or Ratchet Option. Related to Infinite Ladder Option and Shout Option.

Average Credit Spread Long Term Equity Anticipation Securities (LEAPS): An options contract that expires more than 9 months in advance, and can last as long as 2 years. Normal options tend to last no longer than nine months. LEAPS are an excellent way to make a long term option investment. LEAPS trade like normal options, but allow investors to benefit from the appreciation of equities while placing a lot less money at risk than is required to purchase stock.

Average Credit Spread Lookback Option: An exotic option that reduces uncertainties associated with the timing of market entry. There are two types of lookback options: fixed and floating.
Fixed—the option's strike price is fixed at purchase. However, the underlying is priced at its highest or lowest level, depending whether it is a call or put, during the life of the option rather than expiring at market.
Floating—the option's strike price is fixed at maturity. For a call the price is fixed at the lowest price during the life of the option, for a put it is fixed at the highest price. The option settles at market and against the floating-strike.

Average Credit Spread Mid-Atlantic Option: An option that can be exercised at different times during the life of the option. The various times set for exercise are written within the option and allow for flexibility for both the writer and holder of the option. The Mid-Atlantic option is named as such because its exercise dates are more flexible than European options and less flexible than American options. Thus, it is in the middle, similar to the Atlantic Ocean being between Europe and America. Mid-Atlantic options are also referred to as Bermuda, Quasi-American, or Semi-American options.

Average Credit Spread Naked Call Option: An option where the writer of a call option does not own a long position in the stock on which the call has been written. Naked options are very risky. Profits are huge if the underlying asset moves in the direction desired by the buyer. On the other hand, a writer/seller of a naked call option can lose big if the underlying asset moves in the direction desired by the buyer. Sometimes referred to as an uncovered call.

Average Credit Spread Naked Option: An option position where the buyer or seller has no underlying security position. Naked options are very risky. Profits are huge if the underlying asset moves in the direction desired by the buyer. On the other hand, a writer/seller of a naked option can lose big if the underlying asset moves in the direction desired by the buyer.

Average Credit Spread Naked Put Option: An option where the writer of a put option does not have a short position in the stock on which the put has been written. Naked options are very risky. Profits are huge if the underlying asset moves in the direction desired by the buyer. On the other hand, a writer/seller of a naked put option can lose big if the underlying asset moves in the direction desired by the buyer. Sometimes referred to as an uncovered put.

Average Credit Spread Nonqualified Stock Options (NSO): A type of employee stock option where the holder pays ordinary income tax on the difference between the grant price and the price at which the holder exercises the option. NSOs are simpler and more common than ISOs. They're called non-qualified stock options because they don't meet all of the requirements of the Internal Revenue Code to be qualified as incentive stock options.

Average Credit Spread No-Touch Options: A no-touch option is a great way to profit from a trending market. The no-touch option pays a fixed amount if the market never touches the barrier level that the holder chooses. All the holder needs to do is to determine the desired payoff, the currency pair, the barrier price, and the expiration date. As long as the spot level never hits the barrier price before expiry, the holder receives the payoff amount. If the barrier is reached during the option period, the option expires worthless. An example of a no-touch option is the following:

| Currency: | EUR/USD |
|---|---|
| Barrier Price: | 1.0625 |
| Current Spot Level: | 1.0550 |
| Expiration Date: | 7 days from today |
| Payoff: | $3,000 |
| Cost: | $1,000 |
| Net profit if barrier is reached: | $2,000 |

If the spot value never reaches the relevant barrier prior to expiry, then this option is profitable for the buyer. If the spot price reaches the relevant barrier prior to expiry, then there is no payoff at expiry, and therefore this option is unprofitable for the buyer.

Average Credit Spread Option: A call or put option on an average credit spread. For example, options on the S&P 500 are some of the most actively traded options in the world. This type of option is a put or a call option based upon an underlying average credit spread.

Average Credit Spread Option Chain: A way of quoting options prices through a list of all of the options for a given security. It includes the various strike prices, expiration dates, and whether they are calls or puts.

Average Credit Spread Partial Lookback Option: An option that provides a time window of, say, 30 to 90 days, during which the strike price is set or reset at the most favorable level during that period. After that period, the option is an ordinary American-style option. Because the lookback characteristic covers a limited time, the partial lookback option will sell for a price intermediate between a traditional option and a full lookback option. See also Lookback Currency Option, Lookback Strike Option, Reset Option, or Step-Down Option.

Average Credit Spread Path Dependant Option: An exotic option that is valued according to pre-determined price requirements for its underlying asset or commodity. The payoffs associated with these options are determined by the path of the underlying asset's price. Examples include Asian, Barrier and lookback options.

Average Credit Spread Put Option: A put option where the purchaser has the right, but not the obligation, to sell a value as a strike price in the underlying spread to the writer/seller of the contract during a defined period of time at a fixed price, wherein the underlying spread is an average credit spread with numerical values published at regular time intervals. The buyer profits on a put when the underlying spread decreases in value below the purchased value or strike price of the option. A premium is paid by the investor/buyer/holder of the option to the writer/seller of the option for this right. Settlement could require the exchange of the entire transaction value between the buyer and writer/seller, or exchange of the strike price or spread value of the contract less the prevailing market spread value of the underlying average credit spread, times a cash multiple.

Average Credit Spread Quanto Option: An option in one country's currency that pays out in another country's currency. This is usually used when an investor believes that a stock will do well in another country, but fears that the country's currency will not. The investor buys an option in the foreign stock while keeping the payout in his or her home currency.

Average Credit Spread Rainbow Option: An option that is written on more than one underlying asset. Rainbow options are usually calls or puts on the best or worst of n underlying assets, or options which pay the best or worst of n assets. Rainbow options at exercise may deliver either the best or worse asset in the rainbow or a call or put option on the better or worse of the assets. “Multi-color” rainbow options could deliver the best or worst m of the n assets. Spread options are a special case of rainbow options.

Average Credit Spread Rebate Barrier Option: A barrier option that offers a predetermined rebate, should the option be ‘knocked-out.’ Should a rebate be enacted, it will be deducted from the premium paid to the issuer, thus reducing the issuer's potential profit. For this reason, it is uncommon to see a rebate opportunity attached to a barrier option.

Average Credit Spread Reload Option: An employee stock option that grants additional options upon exercise of the original. The employee satisfies the exercise price of their current option with shares rather than cash. The reload option will have the same expiry date as the original option; however, the strike price will be equal to the share price at the time the original option is exercised. Also known as restoration option.

Average Credit Spread Russian Option: A lookback option without an expiry date. This type of option can have either an American or a Mid-Atlantic settlement. It is a perpetual lookback option.

Average Credit Spread Shout Options: An exotic option that allows the holder to lock in a defined profit while maintaining the right to continue participating in gains without a loss of locked in monies. Shout options can be structured so that holders of this contract have more than one opportunity to “shout” or lock in profits. This allows holders to continue to benefit from positive market movements without the possibility of losing already locked in profits due to unfavorable conditions.

Average Credit Spread Up-and-In Option: The name for an option that exists only when the price of its underlying asset has reached a pre-specified price level.

Average Credit Spread Up-and-Out Option: The name for an option that ceases to exist when the price of its underlying asset has reached a pre-specified price level.

Average Credit Spread Vanilla Option: A normal option with no special or unusual features. A “plain vanilla option” is a regular option, the opposite of which is an exotic option.

Average Credit Spread Wild Card Option: An option often associated with treasury-bond or treasury-note futures contracts that permit the short position to delay the delivery of the underlying. This provision allows the short futures contract holder to announce his or her intention to deliver the underlying securities on any notice day before a specified time, which is later than the regular trading hours, in which invoice prices are normally fixed. The security that is delivered is usually the cheapest to deliver on that specific day.

Average Credit Spread Caps, Collars, Corridors, and Floors

Average Credit Spread Cap: An upper limit on the interest rate on a floating-rate note (FRN), or an upper limit on an average credit spread value(s) linked to an average credit spread financial instrument.

Average Credit Spread Collar: An upper and lower limit on the interest rate on a floating-rate note (FRN) or an adjustable-rate mortgage (ARM).

Average Credit Spread Corridor: A combination of an average credit spread cap and an average credit spread floor in order to create a “corridor” within which the floating value of the relevant average credit spread(s) for the financial instrument(s) must remain within a specified period of time in order to become “in the money”.

Average Credit Spread Floor: A lower limit on the interest rate on a floating-rate note (FRN), or a lower limit on an average credit spread value(s) linked to an average credit spread financial instrument.

Average Credit Spread Notes

Average Credit Spread Note: Any debenture, bond, or debt security issued with either principal or interest payments being determined by or linked to an average credit spread. By way of example, such a note may be a three-year note issued by Ford Motor Co. where the coupon is based upon an average three-year BBB-Industrial credit spread for firms in the automotive industry segment.

Average Credit Spread Forwards and Futures

Average Credit Spread Forward Contract: A cash market transaction in which delivery of the commodity is deferred until after the contract has been made. Although the delivery is made in the future, the price is determined at the initial trade date. Most forward contracts don't have standards and aren't traded on exchanges. A farmer would use a forward contract to “lock-in” a price for his grain for the upcoming fall harvest. Note that average credit spread financial instruments do not involve the actual delivery of a commodity, but instead involve settlement based upon the change in value between the spot and forward prices. Settlement could require the exchange of the entire transaction value between the buyer and writer/seller, or exchange of the prevailing market price for the underlying security less the strike “price” or value of the contract. Settlement could otherwise require the exchange of the entire transaction value between the buyer and writer/seller, or exchange of the strike “price” or value of the contract less the prevailing market price for the underlying security.

Average Credit Spread Forward Rate Agreement (FRA): A forward contract that determines an average credit spread(s) upon which payment or reception of an obligation is based beginning at a start date sometime in the future. Also referred to as a “Future Rate Agreement.” Any gain or loss on the agreement is like a gain or loss on an option or futures contract.

Average Credit Spread Futures Contract: An exchange traded agreement to buy or sell a particular type and grade of commodity for delivery at an agreed upon place and time in the future. Futures contracts are transferable between parties. Commodity futures very rarely lead to the delivery of a commodity because positions are usually closed out (“offset”) before the delivery date. In contrast, forward contracts often lead to delivery. Note that average credit spread financial instruments do not involve the actual delivery of a commodity, but instead involve settlement based upon the change in value between the spot and forward prices. Settlement could require the exchange of the entire transaction value between the buyer and writer/seller, or exchange of the prevailing market price for the underlying security less the strike “price” or value of the contract. Settlement could otherwise require the exchange of the entire transaction value between the buyer and writer/seller, or exchange of the strike “price” or value of the contract less the prevailing market price for the underlying security.

Average Credit Spread Managed Futures Account: A managed futures account which combines the different profiles of a variety of average credit spread futures, forwards and options on futures into a composite account or fund. Currently, managed futures are like a mutual fund, except that positions in securities, futures contracts, and options on futures contracts are used to manage the portfolio. Also known as a Commodity Pool.

Average Credit Spread Swaptions

Average Credit Spread Swaption (Swap Option): The option to enter into a credit spread swap. In exchange for an option premium, the buyer gains the right, but not the obligation, to enter into a specified swap agreement with the issuer on a specified future date. The agreement will specify whether the buyer of the swaption will be a fixed-rate receiver (like a call option on an average credit spread financial instrument) or a fixed-rate payer (like a put option on an average credit spread financial instrument). In such an option on a swap agreement, at least one, if not both “legs”, of the swap transaction are dependent on an average credit spread in determining either the coupon rate or the principal amount.

Average Credit Spread Bermuda Swaption: A swaption with predefined limitations on exercise. Similar to a Bermuda option, a Bermuda swaption can only be exercised at certain times during its life.

Average Credit Spread Call Swaption: A financial instrument in which the buyer has the right, but not the obligation, to enter into a swap as a fixed-spread payer. The writer therefore becomes the fixed-spread receiver/floating-spread payer.

Average Credit Spread Put Swaption: A financial instrument in which the buyer has the right, but not the obligation, to enter into a swap as a floating-spread payer. The writer of the swaption therefore becomes the floating-spread receiver/fixed-spread payer.

Average Credit Spread “Op-Swaps”

Average Credit Spread “Op-Swaps”: A swap of options on average credit spreads.

Average Credit Spread Swaps

Swaps allow entities to exchange variable cash flows for fixed payments. They are similar to options but no premium (i.e., up-front money) is paid to obtain the rights. It is essentially an outright trade based on the expected movement of the price of the derivative's underlying commodity, asset or spread.

Average Credit Spread Swap: A swap agreement where at least one, if not both “legs” of the swap transaction are dependent on an average credit spread in determining either the interest rate, coupon rate, the principal amount, or other financial element impacting one or both parties. Traditionally, swaps involved the exchange of one security for another to change the maturity (bonds), quality of issues (stocks or bonds), or because investment objectives had changed. Recently, swaps have grown to include currency swaps and interest rates swaps. The other “leg” of the swap may be dependent on, but not limited to, a fixed interest rate, floating interest rate, currency exchange rate, equity spread (e.g. S&P 500), commodity, or futures contract. If firms in separate countries have comparative advantages on interest rates, then a swap could benefit both firms. For example, one firm may have a lower fixed interest rate, while another has access to a lower floating interest rate. These firms could swap to take advantage of the lower rates.

Average Credit Spread Commodity Swap: A swap where exchanged cash flows are dependent on the price of an underlying commodity. In this swap, the user of a commodity would secure a maximum price and agree to pay a financial institution this fixed price. Then in return, the user would get payments based on the market price for the commodity involved. On the other side, a producer wishes to fix his income and would agree to pay the market price to a financial institution, in return for receiving fixed payments for the commodity.

Average Credit Spread Interest Rate Swap: In this type of swap, an average credit spread is used as one “leg” of the swap. This is a deal between banks or companies where borrowers switch floating-rate loans for fixed rate loans (for example, in another country). These can be either the same or different currencies. The advantage to this is that one company may have access to lower fixed rates and another company may have access to lower floating rates, which leads to a trade.
Fixed Rate Average Credit Spread Swap (average credit spread vs. fixed rate)—one ‘leg’ of the swap will pay an amount based on the average credit spread (e.g. 5-year BBB+Bank credit spread) and the other ‘leg’ will pay a fixed amount (e.g. 0.75%).
Floating Rate Average Credit Spread Swap (average credit spread vs. floating rate)—one ‘leg’ of the swap will pay an amount based on the average credit spread (e.g. average 3-year A-Industrial credit spread) and the other ‘leg’ will pay an amount based on a floating rate spread (e.g. 6-month LIBOR). Due to the flexible nature of credit spreads over time, it is possible to think of average credit spreads as another floating rate spread.

Average Credit Spread Forward Swap: A swap agreement created through the synthesis of two different swaps, differing in duration, for the purpose of fulfilling the specific timeframe needs of an investor. Sometimes swaps don't perfectly match the needs of investors wishing to manage certain risks. For example, if an investor wants to offset risk for a five-year duration beginning one year from today, they can enter into both a one-year and six-year swap, creating the forward swap that meets the requirements for their portfolio. Also referred to as a Forward Start Swap, Delayed Start Swap and a Deferred Start Swap.

Average Credit Spread Amortizing Swap: A swap whereby the notional principal amount of the agreement is amortized according to the movement of an underlying rate. Spread amortizing swaps could be based on LIBOR or interest rates. Also known as “spreaded principal swap”.

Average Credit Spread Quanto Swap: A dual swap combining a currency and/or interest rate transaction (with payment rates or returns denominated in a currency different than the currency used to state the notional principal amount, although both rates are calculated against the base currency). The purpose behind a quanto swap is to minimize foreign exchange risk. This is done by fixing the exchange rate and interest rate at the same time. This is also referred to as a CRoss-Index Basis (CRIB) Swap, Cross-Rate Swap, CUrrency Protected Swap (CUPS), Diff or Difference Swap, Differential Swap, Interest Rate Index Swap, LIBOR Differential Swap.

Average Credit Spread Spreadlock: An agreement that fixes the spread between the forward price of an interest rate swap and its underlying government bond yield. The spreadlock allows a future user of an interest rate swap to take advantage of the current spread between the swap rate and the bond rate. This is achieved by transferring the current savings in basis points to a date in the future, when both parties will enter the interest rate swap.

Average Credit Spread Variance Swap: A type of volatility swap where the payout is linear to variance rather than volatility. Therefore, the payout will rise at a higher rate than volatility. Variance is the square of standard deviation. Because of this, the payout of a variance swap will be larger than that of a volatility swap, as these products are based upon variance rather than standard deviation.

Average Credit Spread Volatility Swap: A forward contract whose underlying is the volatility of a given product. This is a pure volatility instrument, allowing investors to speculate solely upon the movement of a spread's or spreads' volatility without the influence of price. Thus, just like investors trying to speculate on the prices of stocks, by using this instrument investors are able to speculate on how volatile the spread will be.

Additional Terms and Conditions Applicable To Average Credit Spread Financial Instruments

It is a feature of the present invention that each type of average credit spread financial instrument bears a unique identification number. A second number may be assigned to each contract of a particular type of said average credit spread financial instrument.

In one embodiment of the present invention, contracts of an average credit spread financial instrument may be combined with each other to form more complex financial products. Contracts of average credit spread financial instruments may also be combined with other financial securities or spreads to form more complex financial products. The other financial securities or spreads include, but are not limited to, commodity futures and forwards, other spreads such as the S&P 500, foreign exchange rates, domestic and foreign interest rates, equity securities, equity-linked securities or derivatives, equity-linked spreads, fixed-income securities, fixed-income-linked securities or derivatives, and fixed-income-linked spreads. For example, in one embodiment of the present invention, average credit spread financial instruments may be combined with assets to create a class of asset-backed securities or other types of structured financial instruments.

It is also an embodiment of the present invention that additional terms may be added to the documented set of terms that correspond to an average credit spread option, future or other security. Such additional terms may address subjects including but not limited to: risk premiums; financial guarantees and/or covenants; guarantees of compliance with rules, conditions, and disclosure as set forth by the SEC, FASB, OFAC, and other regulatory bodies with oversight of capital markets; conformance to pre-determined financial measures (including but not limited to a specified debt-to-equity ratio, a specified quick ratio or quick asset ratio, and/or a specified net worth); and compliance with legal requirements for: ethical conduct in the ordinary course of business; corporate governance; sound financial management to fulfill obligations for the relevant average credit spread financial instrument; board structure; disclosure of financial condition; and conflicts of interest.

It is a further embodiment of the present invention that additional risk definitions and contingency plans may be added to the documented set of terms that correspond to an average credit spread option, future or other security. Said additional risk definitions and contingency plans may address subjects including but not limited to: potential counterparty risk, potential home market risk, potential currency risk, potential sovereign/provisional/territorial government risk, potential political risk, potential agency risk (government-chartered and/or non-governmental), potential trading and exchange risk, and/or potential syndicate risk.

It is a further embodiment of the present invention that financial guarantees may be “wrapped” or included in the terms of an average credit spread financial instrument. Such guarantees as Letters of Credit (LOC) have a Beneficiary, Obligor, and Guarantor. A Beneficiary requests an LOC from an Obligor as a guarantee against credit exposure. The Obligor will obtain the LOC from a Guarantor in favor of the Beneficiary. LOCs may be drawn against based on contractual provisions. By way of example, financial guarantees include, but are not limited to, the following:

Asset Value Guarantee—Guarantee asset value at a specific time, such as in aircraft leasing.

Bid Bond—To secure an offer to perform a task at a specified price.

Bond Guarantee—The obligation of one person to repay a debt taken on by someone else, should that person default.

Capital Guarantee—Guarantee an agreed upon level of equity.

Certificate of Insurance—Evidence of the existence of an insurance policy issued by the issuer of the policy.

Comfort Letter—Letter guaranteeing payment of obligations.

Commercial Paper Guarantee—Short term obligations issued to investors with temporarily idle cash.

Credit Guarantees—Guarantees the repayment of debt by the obligor.

Equity Swap—Notational principal swap in which the cash flows on at least one leg of the swap are linked to the total return on a single stock, a stock spread, or some combination thereof.

Evergreen Provision—Refers to a provision for automatic roll-over of the LOC unless very specific conditions are met. LOC amounts are reviewed and reset on (generally) an annual basis to reflect changes in underlying exposure.

Financial Guarantee Insurance—Insurance created to cover losses from specified financial transactions.

Funding—Agreement to provide funds to finance a project or debt on or before maturity.

Guarantee—Guarantee payment of and/or performance of obligations.

Guarantee Letter—Guarantees commitment that the Obligor will have working capital at all times to meet obligations.

Hell-or-High-Water Contract—A non-cancelable contract whereby the purchaser must make the specified payments to the seller, regardless of any difficulties they may encounter. Hell-or-high-water clauses bind the purchaser or lessee to the terms of the contract until the contract's expiration. Also known as a promise to pay' contract.

Indemnification—Guarantee to restore to the condition prior to the loss

Irrevocable Letter of Credit—Issued by a bank guaranteeing the payment of a customer's drafts up to the stated amount for a specified period that cannot be changed or terminated without the agreement of the beneficiary.

Irrevocable Standby Letter of Credit—Issued by a bank guaranteeing the payment of a customer's drafts up to the stated amount for a specified period for a particular event that cannot be changed or terminated without the agreement of the beneficiary.

Keepwell Agreement—Guarantee residual values, payments, obligations, net worth as agreed.

Lease/Rent Guarantee—Guarantee real property lease and rent payments.

Letter of Comfort (by Italian Law is a Guaranty)—Guarantee residual values, payments, obligations, net worth as agreed, under Italian law.

Letter of Credit—Issued by a bank guaranteeing the payment of a customer's drafts up to the stated amount for a specified period.

Loss Guarantees on Construction Loans—Agreement to share losses with the beneficiary.

Payment Obligations—Guarantee payment obligations of the obligor.

Performance Obligations—Guarantee performance of policy obligations.

Policyholder Obligations—Fulfillment of insurance contract and to maintain rating from Agency Standard and Poor's.

Standby Letter of Credit—Issued by a bank guaranteeing the payment of a customer's drafts up to the stated amount for a specified period for a particular event.

Surety—A formal pledge to secure against loss.

Tender Guarantee—Offer of money or goods in settlement of a prior debt or claim.

Trust Agreement—A trust agreement is made and entered into by the beneficiary, the grantor (obligor) and a bank (Guarantor). A trust account is created into which assets are deposited.

Other Guarantees—All other financial guarantees.

The information stated in a financial guarantee may include, but is not limited to: naming of Beneficiaries, Obligors, and Guarantors; contact information such as mailing address and phone numbers; notional drawdown amounts; credit ratings and impacts of credit upgrades or downgrades; currency or currencies of denomination; expiry/renewal date if relevant; compliance notes such as dates for regulatory disclosure of commercial commitments or marking and reporting losses for off-balance sheet obligations; the identification of associated collateral; and other information that affects the structure of a financial guarantee.

The inventive average credit spread financial instruments (such as average credit spread options, average credit spread futures, and other average credit spread securities) utilize an average credit spread (instead of a stock or bond price) as the underlying value upon which the financial instrument's value is computed. These average credit spreads may either be computed or are published by sources mentioned previously in this document, for market segments defined by geography, credit history, industry type, industry size, firm size, provision of collateral, third-party guarantee, or type of debt obligation. As will be readily apparent to one skilled in the relevant art(s), the present invention can easily be applied to utilize average credit spread information for said market segment(s) computed or published anywhere in the world, and average credit spread financial instruments could easily be created and traded in capital markets anywhere in the world. The present invention may also be applied to other forms of deriving aggregated credit spread information, such as, but not limited to, median credit spreads, variance-based credit spreads, or other statistical forms of subdividing said market segments with regard to aggregated credit spread information.

It should be noted that for such average credit spread financial instruments to operate in an open market, parties have to agree on the precise spread to be used, as the next published numbers of this spread will trigger a change in value of the financial instruments. Furthermore, it will be apparent to one skilled in the relevant art(s) the parties may need to define all terms of the contract within the contract itself to avoid legal disputes. It should also be noted that prices on average credit spread financial instruments may be quoted in either fraction or decimal formats.

Derivatives, being financial instruments, may be traded among investors as are stocks, bonds, and the like. Thus, in order to trade derivatives, there must be a mechanism to price them so that traders may exchange them in an open market. To date, there is no organized exchange for average credit spread financial instruments (or derivates, as they may be alternately referred to in these descriptions of the present invention), as they are traded as over-the-counter (OTC) instruments, typically between two counterparties conducting a private transaction not open to other investors. The present invention of average credit spread financial instruments would be made available via exchanges (both electronic and open outcry), ECNs (electronic commerce networks such as Instinet or Archipelago), broker/dealer networks (ex. Everen Securities) and via OTC (over the counter) transactions and via private transactions between two or more counterparties or legal entities.

The relationship between the value of a derivative and the underlying asset are not linear and can be very complex. Economists have developed pricing models in order to perform valuation of certain types of derivatives. As is well known in the relevant art(s), the Black-Scholes option pricing model is the most influential and extensively used pricing model. The Black-Scholes model is based on stochastic calculus and is described in detail in a variety of publicly available documents, such as Chriss, Neil A., The Black-Scholes and Beyond Interactive Toolkit: A Step-by-Step Guide to In-depth Option Pricing Models, McGraw-Hill, 1997, ISBN: 078631026X (USA), which is incorporated herein by reference in its entirety.

Whether using the Black-Scholes or any other pricing model, each has inherent flaws and thus poses risks. It has been estimated that some 40% of losses in dealing with derivatives can be traced to problems related to pricing models. Risks in relying on any model include errors in the model's underlying assumptions, errors in calculation when using the model, and failure to account for variables (i.e., occurrences) that may affect the underlying assets.

Therefore, given the fact that average credit spread-linked financial instruments and/or derivatives have been overlooked in the development of financial products, existing models have considered past average credit spreads, and also with respect to the newly-developed present invention described in this document, what is needed is a mechanism to price average credit spread-linked financial instruments so that parties may exchange them in an open market. The mechanisms used to price real estate-linked financial instruments may include, but is not limited to, the following:

1. Black-Scholes Option Pricing Model

2. Binomial Lattice Models

3. Trinomial Lattice Models

4. Monte Carlo Simulations

Black-Scholes Model

The Black-Scholes model developed in 1972 was the original option-pricing model for the valuation of European style options. European style options are options that have as a characteristic that they cannot be exercised before the expiration date. Its principles serve as the foundation in almost all options formulas used today.

Fischer Black and Myron Scholes developed their option pricing model under the assumptions that the underlying prices change continuously and that the returns of the underlying follow a log-normal distribution. Also, they assume that the interest rate and the volatility of the underlying remain constant over the life of the option.

The Black-Scholes model as originally developed pertained only to options on underlying with no dividend payment. The calculator used here has been adjusted for the Black-Scholes model to account for dividends.

The Black-Scholes equation is usually written as C=S*N(d₁)−Ke^{-(rt)}*N(d₂), where the notation is fairly standard, as described by P. Wilmott, J. N. Dewynne and S. Howison, “Option Pricing: Mathematical Models and Computation”, Oxford Financial Press, Oxford (1993).

Binomial Option Pricing Model

An option pricing model in which the underlying asset can assume one of only two possible, discrete values in the next time period for each value that it can take on in the preceding time period. This is a simple model used to price options by reducing possibilities of price changes, removing the possibility for arbitrage, assuming perfectly efficient markets, and shortening the duration of the option. The binomial approach assumes a risk neutral approach to valuation, assuming that underlying security prices can only increase or decrease with time until the option expires worthless.

The binomial model, developed by Cox and Rubinstein, breaks down the time to expiration into potentially a very large number of time intervals, or steps. A tree of the underlying prices is initially produced working forward from the present to expiration.

At each step it is assumed that the underlying price will move up or down by an amount calculated using volatility and time to expiration. This produces a binomial distribution, or recombining tree, of underlying prices. The tree represents all the possible paths that the underlying price could take during the life of the option. At the end of the tree—i.e. at expiration of the option—all the terminal option prices for each of the final possible stock prices are known, as they simply equal their intrinsic values.

The option prices at each step of the tree are calculated working back from expiration to the present. The option prices at each step are used to derive the option prices at the next step of the tree using risk neutral valuation based on the probabilities of the underlying prices moving up or down, the risk free rate and the time interval of each step. At the top of the tree there will only be left one option price, which is known as the theoretical or fair value of the option.

For European options, the binomial model converges on the Black-Scholes formula as the number of steps in the binomial calculation increases. In fact the Black-Scholes model for European options is really a special case of the binomial model where the number of binomial steps is infinite. In other words, the binomial model provides discrete approximations to the continuous process underlying the Black-Scholes model.

To derive the formula for Binomial pricing model, begin by dividing the life of an option into a large number of small time intervals of length dt. Assuming that the initial value of the spread is S, the value S can increase to Sᵤ or decrease to S_{d} when the next time interval comes. Hence spread can move from its initial value of S to one of two new values, Sᵤ and S_{d}. The movement from S to Sᵤ is therefore an “up” movement and the movement from S to S_{d} is a “down” movement. The probability of an up movement will be denoted by p while the probability of a down movement is (1-p).

Trinomial Model

The Trinomial Model is very similar to the Binomial Model except that at each time interval it is assumed that the underlying spread S will move up Sᵤ or down S_{d} by an amount or remain the same S. The initial spread level, interest rates and the volatility define the nature of the trinomial lattice. If the probability of an up movement is denoted as pᵤ while the probability of a down movement is denoted by p_{d}, the probability for the across movement will be (1-pᵤ-p_{d}).

Once the array of the underlying spread has been set up by working forwards through the trinomial tree, the option price array is calculated by working backwards from the option expiry. At option expiry, the options are initialized to their intrinsic value. In discounting back from the expiry to the present, the option price at each interval is calculated as the minimum of the exercise (strike) price and the discounted value of holding the option over the time period. Once the option price array has been populated, the theoretical (fair) option value is the value of the option at t=0 or at present.

Monte Carlo Simulation

An analytical technique for solving a problem by performing a large number of trial runs, called simulations, to analyze the effect of varying inputs on the outputs of a model, such as a stock price. The simulations will infer a solution from the collective results of the trial runs. The Monte Carlo simulation randomly generates values for uncertain variables over and over to simulate a model, and calculates the probability distribution of possible outcomes.

Other Methods

While Black-Scholes model is a popular model used for option pricing, other models exist that consider different factors. No model can be entirely accurate. The pricing models used here are not intended to provide a complete list of methodologies for valuing financial instruments, but rather as an exploration of the many ways in which financial instruments can be assessed in order for a trader to determine whether an instrument is a desirable investment or not. In fact, as will be readily apparent to those skilled in the relevant art(s), there are a multitude of methodologies, formulae and pricing models by which one can determine whether a financial instrument is over-, under- or fairly priced when compared with its market value. Examples of alternative methodologies would include, but are not limited to, closed form solutions and neural networks.

Also, as a workflow to be included in a preferred embodiment of the present invention, “black box” computer programs may be used, wherein the user enters information and the system utilizes pre-programmed logic (ex. formulas, calculations) to return output to the user, which may include by way of example buy or sell signals and other optimal or useful information output.

Option Model Inputs

By way of example, there are eight inputs for a call or put option:
Option Type: A Call or a Put
Underlying Price: Value of the underlying spread, e.g. airline industry market segment
Exercise Price of Option: Strike price of the Option e.g. 140
Dividend Yield: In percentage. e.g. 1.72%
Interest Rate: In percentage. e.g. 3.12%
Volatility: In percentage. e.g. 25%
Valuation Date: e.g. 9-Oct-04
Exercise Date: e.g. 7-Jan-05

Other types of average credit spread financial instruments may require additional inputs.

Additional valuation measures like Intrinsic Value, Time Value and Implied Volatility of average credit spread financial instruments will be calculated immediately upon input of the financial instrument's market value.

Intrinsic Value and Time Value

The intrinsic value of a call is the amount by which the spread is above the call's strike price. The intrinsic value of a put is the amount by which the spread is below the put's exercise price. Time value is that portion of an option's total price in excess of intrinsic value. As the intrinsic value increases, the time value decreases.

Consider the following illustration: A call and a put on the same underlying have the same exercise price of 700. Current underlying price is at 720, the call costs RM 25 and the put costs RM 5. The intrinsic value of the call is 20 (=720−700) and of the put is 0 (since the spread is above the put's exercise price). The time value of the call is 5 (=25−20) while that of the put is 5 (=5−0).

Implied Volatility

Implied volatility is the volatility percentage that explains the current market price of a financial instrument. As the forces of supply and demand determine the market price of a financial instrument, the volatility percentage must be adjusted to explain the market price of said financial instrument. The implied volatility that produces the financial instrument's market price as the theoretical value is the implied volatility.

The present invention is directed to a system, method, and computer program product for the valuation (and thus, processing and trading) of average credit spread financial instruments, and/or financial instruments that are affected by average credit spreads. In an embodiment of the present invention, an organization which trades average credit spread instruments may provide a brokerage desk that facilitates average credit spread financial instrument trades for clients or for its own proprietary account, as well as providing an interactive World Wide Web site accessible via the global Internet for real estate predicted future spreads and spread information, pricing models, and trade execution services. Said organization may also provide information and data sets that enable traders to identify and capitalize on market fluctuations affecting or driven by average credit spreads. The infrastructure supporting these operations may be an organized electronic exchange, open outcry exchange, broker/dealer system, ECN (electronic commerce network), or OTC process for average credit spread financial instruments. Such average credit spread financial instruments may also be created as custom products for particular entities, and may only be tradeable to another entity or entities which wish to take delivery of such a custom average credit spread financial instrument.

Such a system also allows entities to intelligently trade and use average credit spread financial instruments not only to manage credit risks, but also to speculate for profit. These entities may trade with each other in any multi-party combination or with internal legal entities, and include but are not limited to:
1. Sovereign governments (ex. United States)
2. Government agencies (ex. Fannie Mae, Freddie Mac, Ginnie Mae)
3. Non-governmental organizations (ex. International Monetary Fund, World Bank, Inter-American Development Bank)
4. Pan-governmental organizations and treaty organizations (ex. European Union, African Union, Mercosur, NAFTA)
5. Territorial governments (ex. Puerto Rico, U.S. or U.K. Virgin Islands, Macau, Greenland)
6. Autonomous or semi-autonomous/privileged regions contained within a sovereign entity (ex. Hong Kong [of the People's Republic of China])
7. Provisional governments
8. Governments recognized by at least one other member of the United Nations (ex. Republic of China a.k.a. Taiwan [recognized only by Sao Tome], Turkish Cyprus [recognized only by Turkey])
9. Commercial banks
10. Investment banks
11. Commercial/Investment banks (ex. Citigroup)
12. Investment boutique firms
13. Private equity firms (ex. Carlyle Group)
14. Commodity trading entities (including fuel and power, such as Dynegy, the former Enron, and the former Mirant)
15. OTC trading entities
16. Insurance companies (ex. Aetna)
17. Reinsurance companies (ex. Munich Re)
18. Insurance/financial services hybrids (ex. AIG, Citigroup [Travelers])
19. Mutual funds (ex. Vanguard, Fidelity)
20. Venture capital funds (ex. Kleiner Perkins Caufield Byers)
21. Hedge funds
22. Broker/dealer networks (ex. Everen Securities)
23. Electronic brokers (ex. E-trade)
24. Electronic commerce networks (ex. Instinet or Archipelago)
25. Open outcry exchanges and their members (ex. Eurex, CBOT, AMEX)
26. Retail investors of any level (such as groups of corporate or private debtors, individual/proprietor, partnership, limited liability company, S corporation, and C corporation, either public or private.)

The present invention is designed to support all business and regulatory requirements for any of these parties transacting with each other in the trade of average credit spread financial instruments. The present invention is described in terms of the above example. This is for convenience only and is not intended to limit the application of the present invention. In fact, after reading the following description, it will be apparent to one skilled in the relevant art how to implement the following invention in alternative embodiments and without limitation for the benefit of anyone whose “bottom line” can be affected by investing in average credit spread financial instruments.

II. System Architecture Overview

A. System Components

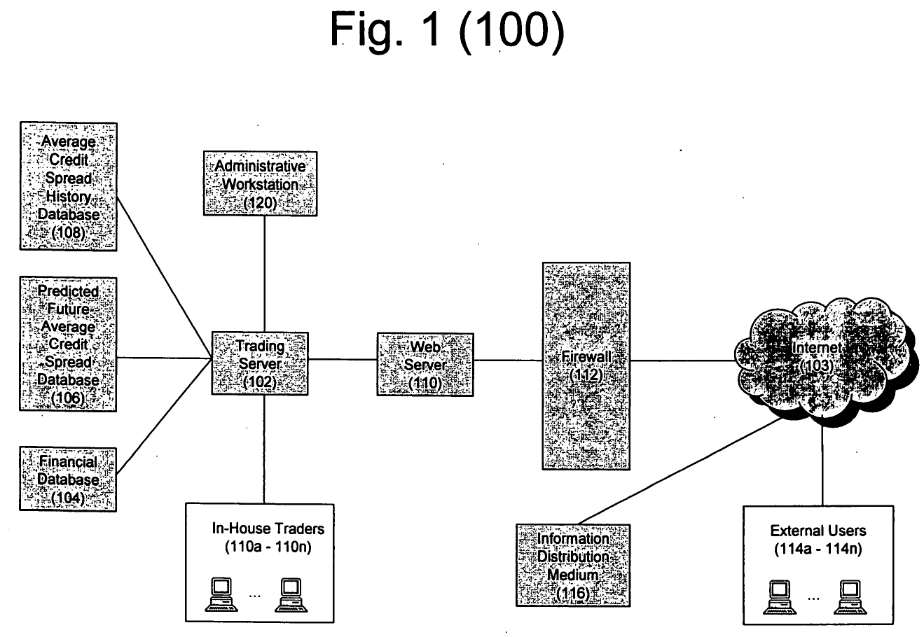

Referring to FIG. 1, an average credit spread trading system 100, according to an embodiment of the present invention, is shown. It should be understood that the particular trading system 100 in FIG. 1 is shown for illustrative purposes only and does not limit the invention. Other implementations for performing the functions described herein will be apparent to persons skilled in the relevant art(s) based on the teachings contained herein, and the invention is directed to such other implementations. As will be apparent to one skilled in the relevant art(s), all of components “inside” of the trading system 100 are connected and communicate via a communication medium such as a local area network (LAN) 101.

The trading system 100 includes a trading server 102 that serves as the “back-end” (i.e., average credit spread processing system) of the present invention. Connected to the trading server 102 is a financial database 104, an average credit spread history database 108, and/or a predicted future average credit spread database 106. The trading server 102 is also connected to a Web server 110. As is well-known in the relevant art(s), a Web server is a server process running at a

Web site which sends out web pages in response to Hypertext Transfer Protocol (HTTP) requests from remote browsers. The Web server 110 serves as the “front end” of the present invention. That is, the Web server 110 provides the graphical user interface (GUI) to users of the trading system 100 in the form of Web pages. Such users may access the Web server 110 at the average credit spread trading organization's site via a plurality of internal workstations 110 (shown as workstations 110a-n).

A firewall 112 serves as the connection and separation between the LAN 101, which includes the plurality of network elements (i.e., elements 102-110 and 120) “inside” of the LAN 101, and the global Internet 103 “outside” of the LAN 101. Generally speaking, a firewall—which is well-known in the relevant art(s)—is a dedicated gateway machine with special security precaution software. It is typically used, for example, to service Internet 103 connections and dial-in lines, and protects a cluster of more loosely-administered machines hidden behind it from an external invasion.

The global Internet 103, outside of the LAN 101, includes a plurality of external workstations 114 (shown as workstations 114a-n). The external workstations 114 allow client-users (traders) of the average credit spread trading organization to remotely access and use the trading system 100.

The trading system 100 includes an administrative workstation 120 that may be used by the trading organization to update, maintain, monitor, and log statistics related to the server 102 and the trading system 100 in general. Furthermore, FIG. 1 depicts an information distribution medium 116 connected to the Internet 103. This is to signify that information distribution medium 116 or other similar tools may access trading system 100 for the purposes of, but not limited to, publishing the trading organization's real estate predicted future spreads for users, according to an embodiment of the present invention.

While one trading server computer 102 is shown in FIG. 1, it will be apparent to one skilled in the relevant art(s) that trading system 100 may be run in a distributed fashion over a plurality of the above-mentioned network elements connected via LAN 101. Similarly, while several databases (i.e., 104, 106, and 108) are shown in FIG. 1, it will be apparent to one skilled in the relevant art(s) that trading system 100 may utilize databases physically located on one or more computers which may or may not be the same as sever 102. More detailed descriptions of the trading system 100 components, as well as their functionality, are provided below.

1. Average Credit Spread History Database

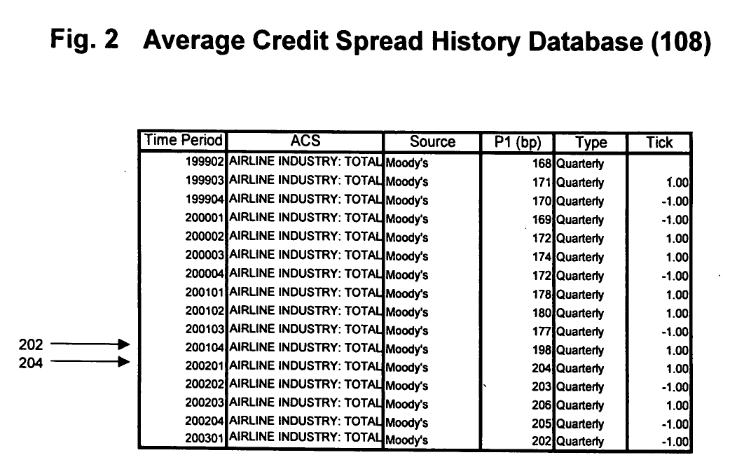

An example average credit spread history database 108 is shown in FIG. 2. The average credit spread history database 108 includes, for each time period in the view, one or more records for each relevant market segment. The average credit spread history database 108 contains but is not limited to data on market segments defined by geography, credit history, industry type, industry size, firm size, provision of collateral, third-party guarantee, or type of debt obligation. These records contain information specifying the average credit spread information that occurred in the subject market segment in the time span represented in the view. Specifically, for each market segment, there is a record for each of several average credit spread data types.

In an embodiment of the present invention, the average credit spread history database 108 contains all past historical average credit spread data including the most recently computed or published “present” value. There are different classes of average credit spread data types in the average credit spread history database 108. Classes of spread values may be defined by a variety of time periods and with different methods of summarizing information. The classes may include, but are not limited to, quarterly spread values, quarterly change, annualized quarterly values, moving quarterly averages, annual spread values, annual change, moving annual averages, five-year spread values, five-year change; five-year annualized change, and moving five-year averages. As will be apparent to one skilled in the art(s), other time periods and summarization techniques may be used to present information on average credit spreads within average credit spread history database 108.

The “tick” columns in FIG. 2 simply denote whether a change in an average credit spread value is an uptick or downtick. An uptick or increase in the value of the spread sets the tick value to 1, while a downtick or decrease in the value of the spread sets the tick value to −1. If there is no change in value, the tick value equals 0. Of course, values other than 1, 0, and −1 could be alternatively used to indicate these relationships. Also, other average credit spread data types may be used, and the processing of tick values may be applied across both the average credit spread history database 108 and the predicted future average credit spread database 106. Each recorded tick (either uptick or downtick) in the price of a security is written to the average credit spread history database, for the purpose of keeping track of the number and value of consecutive incremental price movements (both upwards and downwards) for the average credit spread-linked financial instrument in question. The average credit spread history database is updated after each trade by performing a write SQL statement which adds the abovementioned information.

The historical average credit spread information in the average credit spread history database 108 is provided on a per period basis. As indicated above, the period may be any increment of time, such as intraday, daily, weekly, bi-weekly, monthly, bimonthly, quarterly, semi-annually, annually, etc. Preferably, the increment of time represented by a period is the same in both of the average credit spread databases (106 and 108) within trading system 100.

Each average credit spread includes one or more data components. For example, the airline industry market segment includes quarterly growth rates, annualized quarterly growth rates, five-year cumulative growth rates, and other elements. For any given period, the values of these data components comprising the average credit spreads are represented by the entries in the average credit spread history database 108 and are linked to the appropriate category data type. For example, in the first quarter of 2002, the quarterly average credit spread for said airline industry market segment was 204 bp (basis points), up from a previous market segment average credit spread value of 198 bp in the fourth quarter of 2001 (see records 202 and 204 in FIG. 2 for a general representation). This average credit spread value may be replicated in a reference file where it is stored in an abbreviated format called P₁R₁, with P₁ representing the period of time and R₁ representing the particular average credit spread to be referenced. This file is used as the “look up” to allow the system to determine which instrument values will change in response to the change in the underlying average credit spread (in this example, the said airline industry market segment's average credit spread value).

2. Predicted Future Average Credit Spread Database

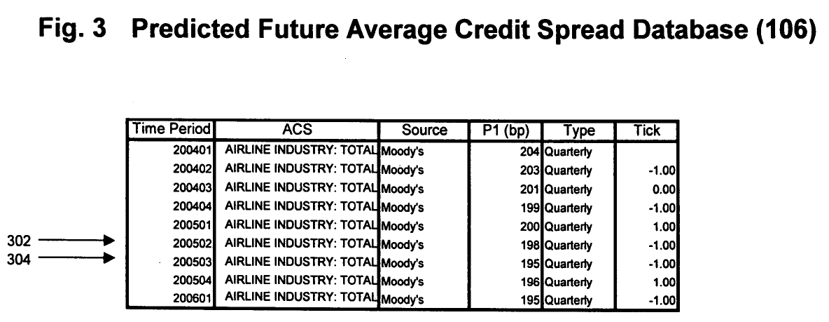

An example predicted future average credit spread database 106 is shown in FIG. 3. The predicted future average credit spread database 106 includes, for each future time period in the view, one or more records for each market segment. These records contain information specifying the average credit spread value that is predicted to occur in the subject market segment in the future time span represented in the view. Specifically, for each market segment, there is a record for each of several average credit spread data types.

The average credit spread predicted future database also contains several classes of average credit spread data types, as in the average credit spread history database 108, which are for a variety of predicted future average credit spread values. These categories are the same as those described above with respect to the average credit spread history database 108. Accordingly, the description above of the average credit spread history database 108 also applies to the average credit spread predicted future database 106.

3. Relationship Between Past and Future Databases

As evident by the description above, the average credit spread history database 108 is a past database because it contains history information. In contrast, the predicted future average credit spread database 106 is a future database because it contains information pertaining to predicted average credit spread movement in the future. Both databases contain information on a per period basis. Preferably, the increment of time represented by a period is the same in both databases. Also, the periods in both databases are synchronized in order to aid the transfer of information between the two databases.

4. Time Periods

As discussed above, data may be stored in the average credit spread history database 108 using any time increment or period, including but not limited to daily, weekly, monthly, quarterly, etc.

Similarly, predicted future average credit spread information for each location may be stored in the predicted future average credit spread database 106 on a daily basis, a weekly basis, a monthly basis, or a quarterly basis. Preferably, the time increment/period is the same in both databases 108 and 106. In practice, a system administrator will select the time increment(s)/period(s) during an administrator setup process using administration workstation 120 in order to meet the demands of traders using the plurality of workstations 110 and 114.

5. Financial Database

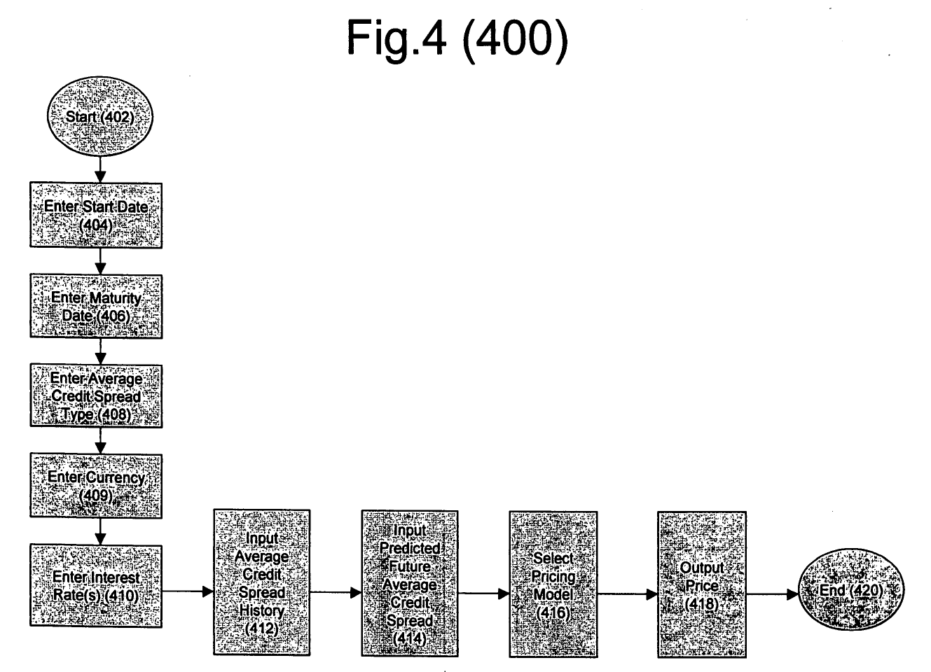

The financial database 104 of trading system 100 contains current financial data that is used by the trading server 102. The financial database 104 includes information relevant to calculating an investment's risk-free rate of return. Such information, as will be apparent to one skilled in the relevant art(s), may include but is not limited to one or more of the Discount Rate, the Prime Interest Rate, the 90-day Treasury Bill, the London Interbank Offered Rate (LIBOR), the Eurodollar Rate, and the like. As will be explained below with reference to FIG. 4, the risk-free rate information within the financial database 104 is necessary for determining the cost-of-cash during the operation of the trading system 100. The financial database 104 may include additional financial information on an application specific basis.

6. Information Retrieval and Dissemination from Databases

The user may choose any number of the above categories of information for display or download for the information in said average credit spread history database 108, real estate predicted future database 106, and financial database 104, by an on-screen selection or check list. After the categories of information have been chosen, the user may execute the research via a selection option on the keyboard or via mouse and graphical user interface (GUI). The system then compiles and executes a selection of SQL query calls according to all selections made by the user. The query results are compiled and prepared for display. Once the results are compiled, pre-programmed graph, trend line and textual templates are used to display the query results on the GUI client display for all chosen securities and information categories described above. After display, the user is given the option to download the displayed results and underlying query data. The user is allowed to select from a variety of download formats, such as ASCII, xbase, dbf, HTML, XML, FPML, MDDL, tif, gif, bmp, or the like. The user is allowed to choose a download location on the local client. The system then proceeds to compile the data into the chosen format. The data is then transferred, using any one of a variety of protocols such as zmodem, xmodem, ftp, TCP/IP, or any one of the OS industry standard protocols.

7. Data Feeds and Data Distribution

In a preferred embodiment of the present invention, the average credit spread history database 108 and the predicted future average credit spread database 106 can provide information for the purpose of distributing information in information distribution medium 116 or for resale as a data feed to a data vendor (including, but not limited to, Bloomberg, Fitch, Moody's, Reuters, Standard & Poor's, Dun and Bradstreet, any physical or electronic exchange, any Small Order Execution Service (SOES) or electronic commerce network (ECN) or broker/dealer network, and/or other commercial services). The data to be distributed could include, but is not limited to, the following:
1. Average credit spread historical value per market segment per time period
2. Predicted future average credit spread value per market segment per time period
3. List of average credit spread financial instruments currently being traded, and/or list of average credit spread financial instruments that were previously traded but are no longer listed.
4. Number of contracts in circulation per average credit spread financial instrument (“open interest”)
5. Characteristics of each average credit spread financial instrument (ex. volatility, price quoted in either fractional or decimal format, expiry date or alternatively time to maturity, etc.)
6. Metrics linked to the characteristics of average credit spread financial instruments (ex. total annual return for the holder of said instrument, total annual portfolio return for the holder of several types of average credit spread financial instruments, etc.)
7. Last trading price of each particular average credit spread financial instrument
8. Price movement of last trading price in relation to the previous price movement
9. Price movement since the previous week, previous month, year to date, previous 52 weeks, or over other measurable periods of time, expressed either in discrete terms or in percentage of change.
10. Lists of spreads with particular movement qualities, including, by way of example only, “10 best performers” over a measurable time period, “10 worst performers” over a measurable time period, and “10 most active” spreads in terms of trading volume of financial instruments of a specific class linked to said spreads. As will be apparent to one skilled in the relevant art(s), it is within the scope and spirit of the present invention to allow a variety of combinations in presenting such statistics.
11. Put-call ratio applicable to options on each particular average credit spread.
12. Long-short ratio applicable to financial instruments linked to each particular average credit spread.
13. Number of total contracts of each type traded in a trading day (“volume”).
14. Currency value, in each applicable currency of denomination, of all trades of each contract type traded in a trading day.
15. Number of buy vs. sell trades executed in a trading day
16. Number of contracts involved in buy trades in a trading day vs. number of contracts involved in sell trades in a trading day.
17. Total short interest in a particular type of average credit spread financial instrument, expressed either as the discrete volume of contracts sold short for a type of average credit spread financial instruments, and/or a percentage of the total number of contracts outstanding of an average credit spread financial instrument that have been sold short.
18. The prevailing stop limit order for each average credit spread financial instrument, as well as relevant volume figures for said instrument.
19. External factors such as changes in a variety of published interest rates, published inflation rates, and other published economic indicators which may impact average credit spread financial instruments. By way of example, an increase or decrease in interest rates could trigger algorithmic calculations which affect terms and pricing for many average credit spread financial instruments and also currency values (ex. interest rates for money market account funds that have not yet been invested in an average credit spread-linked security) tracked within the system.

As will be apparent to one skilled in the relevant art(s), other calculations are possible based upon this list and based upon the present invention in total. For example, by having the total number of buy trades vs. sell trades executed in each trading day, it would be possible to sum up and publish the total number of buy trades vs. sell trades executed in an entire month, or year. In a further embodiment of the present invention, such information may be packaged within a front-end interface GUI module with trade execution, account management, and research reporting capabilities, for sale to and use by users such as individual or institutional traders, analysts, portfolio managers, and others (already noted within these claims for the present invention) as entities whose “bottom line” may be affected by investing in average credit spread financial instruments. Also, it is an embodiment of the present invention that such data feeds may be either automated or managed manually. Finally, it is another embodiment of the present invention that input streams to the average credit spread history database 108 may be taken and sent out again as part of the outbound data streams. Such input streams could include, but are not limited to, data updates received directly from the systems of average credit spread publishers, if such a spread publisher has said system that provides data output that would be recognized as data input by the present invention.

It is also a preferred embodiment of the present invention that such data streams may be adjusted to define and output fundamental data relating to the value of a security on given dates with search limitations relating to technical trading rules, holidays, and historical events, business events, government reports, trigger dates (for financial guarantees, by way of example), and even particular days of the week, weeks, months, or years. For example, in the preferred embodiment of the present invention, a user can request a bar chart of industry segment average credit spreads on all days when the report was either computed or released by its publisher, or the data affecting all related and affected interest rates after a prime rate increase. Such a search could be further limited to stipulate that only those occurrences between Memorial Day and Labor Day when the prime rate was over 3% should be output. In addition, in conjunction with average credit spread information and average credit spread financial instrument information, the database may output commonly-available market averages information, such as the Dow Jones averages each day over extended periods, or commonly-available economic indicators information such as the producer price index, global GNP or GDP figures, revenue and profit data for specific companies, and other such information, together with the dates upon which this information is released if appropriate, such as, but not limited to: major holidays, government holidays, international holidays and/or foreign holidays, special holidays, triple-witching days, contract expiration days, bear or bull market days, expiry/renewal days for financial guarantees such as letters of credit, and the like. The days and holidays may be denoted for the purpose of system alerts to users, or for denoting specific days such as Christmas as invalid trading days. Average credit spread financial instruments will already carry a maturity date or date of expiration within their definition, so that they will become expired upon either exercise prior to the maturity date of said instrument, or will become expired if the maturity date passes without any exercise action on the part of the holder of said financial instrument.

III. The Black-Scholes Pricing Model

Before detailing the operation of the present invention, it is important to detail the specifics of the Black-Scholes pricing model. It is noted that, for illustrative purposes only, the invention is described with reference to the Black-Scholes pricing model. However, the invention is not limited to this described embodiment. Instead, embodiments of the invention utilize variations of the Black-Scholes pricing model discussed herein. Also, other embodiments of the invention utilize pricing models other than the Black-Scholes model, such as binomial models, trinomial models, Monte Carlo simulations, closed form solutions and neural networks. The following description applies to such other embodiments of the invention. The Black-Scholes formula for determining the price of a call option, C, using the five parameters essential to the pricing of an option: (1) the strike price K; (2) the time to expiration t, (3) the underlying commodity price S; (4) the volatility of the commodity σ (“sigma”); and (5) the prevailing interest rate r, is shown in equation (2):
C=S*N(d₁)−Ke^{-(rt)}*N(d₂₎ (2)

As will be apparent to one skilled in the relevant art(s), e is the exponential function—the inverse of the natural logarithm ln—that is equal to, up to four significant decimal places, 2.7183. The variables d₁ and d₂ within equation (2) are expressed as shown in equations (3A) and (3B), respectively:
d₁=[ln(S/K)+(r+σ²/2)^{t}]/σ√t (3A)
d₂=d1−σ∞t (3B)

The function “N( )” is the standard normal distribution function, which, as is well known in the relevant art(s), may be accurately approximated for any value z using equation (4):
N(z)=1−(1/(√2*π)*e^{-z2/2}*(b1*k+b2*k²+b3*k³) (4)

Further, the variable k used in equation (4) is defined as shown in equation (5):
k=1/(1+a*z) (5)

The values a, b1, b2, b3 are constants equal to {a=0.33267; b1=0.4361836; b2=−0.1201676; and b3=0.937298}.

Having presented the Black-Scholes formula for a call option, equation (6) describes the expression for the price P of a put option:

P=C−S+Ke^{-(rt)} (6)

Having presented the Black-Scholes pricing model, the operation of the present invention and its application to pricing average credit spread financial instruments may now be explained. However, as indicated above, while the present invention is described in terms of adopting the Black-Scholes model to apply to average credit spread financial instruments, it will be apparent to one skilled in the relevant art(s), that other pricing models may be so adopted. Examples of these alternative pricing models have already been discussed, including but not limited to binomial models, trinomial models, Monte Carlo simulations, and other models including but not limited to closed form solutions and neural networks.

IV. General System Operation

Referring to FIG. 4, a flowchart 400 representing the operation of trading system 100, according to an embodiment of the present invention, is shown. Flowchart 400 begins at step 402 with control passing immediately to step 404.

A. Inputs

In steps 404 and 406, the start date and the maturity date, respectively, of the contract are entered into the average credit spread trader server 102 of trading system 100. In step 408, the market segment(s) which serves as the subject of the contract is entered. The segment type can be a single type or a plurality of types. That is, the market segment may be a single market segment or a collection (i.e., “basket”) which includes a plurality of different market segments, each of which could have different weightings in the basket. In step 409, the currency denomination which serves as the basis of the contract is entered (in some embodiments, multiple currency terms can be entered in any number of inter-relationships). Then, in step 410, the cost of cash is entered. The cost of cash (i.e., the risk-free rate) information may be read from the financial database 104 of the trading system 100, or may be obtained from another source, including, but not limited to, an on-line financial service. The above information may be entered by a user by using a graphical user interface screen, for example.

In an embodiment of the present invention, the user of system 100 may enter the time period (steps 404 and 406), the market segment(s) (defined by geography, credit history, industry type, industry size, firm size, provision of collateral, third-party guarantee, or type of debt obligation), (step 408), the currency(s) of denomination (step 409), and the average credit spread history and predicted future average credit spread information, as well as financial information, which will automatically be retrieved from the appropriate databases (see FIG. 1) to populate the GUI screen.

B. Processing and Output

In step 412, the average credit spread history database 108 is read so that the trading server 102 has the correct information for processing. The information read from the average credit spread history database 108 includes the past average credit spread information for one or more fixed past time periods for market segments defined by geography, credit history, industry type, industry size, firm size, provision of collateral, third-party guarantee, or type of debt obligation, as entered in step 408. Alternatively, the trading server 102 could query and obtain the average credit spread information from some other source, such as a commercial or governmental service. As mentioned above, average credit spread history database 108 contains the data necessary to provide the trading server 102 the particular average credit spread information, including currency denomination and related regulatory terms, which serve as the basis for the contract.

In step 414, the predicted future average credit spread 106 is read so that the trading server 102 has the correct information for processing. That is, the trading server 102 queries the predicted future average credit spread database 106 (or obtain the information from some other source, such as a commercial service) for the period represented by the start and maturity dates entered in steps 404 and 406, respectively. As mentioned above, predicted future average credit spread database 106, similar to average credit spread history database 108, contains the data necessary to provide the trading server 102 with the particular real estate information (including currency denomination) which serves as the basis for the contract as entered in step 409. During step 414, the average credit spread server 102 may identify the predicted future average credit spread movement pattern that occurs in the future time period in the selected location specified by steps 404, 406 and 408. Consider, for example, predicted future average credit spread database 106 shown in FIG. 3. As indicated by records 302 and 304, the predicted future average credit spread movement pattern in the airline industry market segment in future period T₁ may be replicated in a reference file where it is stored in an abbreviated format called T₁R₁, with T₁ representing the period of time and R₁ representing the particular average credit spread to be referenced. This file is used as the “look up” to allow the system to determine which instrument values will change in response to the change in the predicted future value of the underlying average credit spread (in this example, the said airline industry segment).

After the completion of steps 402 to 414, the trading server 102 of trading system 100 may now calculate the price of an average credit spread derivative (e.g. average credit spread call option). Normally four parameters of equation (2), K, S, r, and t, can be figured with particularity. However, the volatility of a commodity (e.g., a stock or any other underlying asset, security or spread), σ (sigma), cannot. With this parameter, human judgment comes into play to quantify. There are traditionally two methods for measuring volatility—historical and implied. This is where future movement of average credit spreads must be considered.

As mentioned above, most models assume that, for example, last year's real estate cycles (and therefore the effect of those cycles upon the spreads discussed heretofore in this document) will repeat from year to year. Historical analysis has shown, however, that this assumption does not always hold true. Thus, the present invention can make use of predicted future average credit spread database 106 (in conjunction with average credit spread history database 108) to arrive at a more accurate volatility calculation, and thus a better option price.

In step 416, a pricing model (e.g., the Black-Scholes pricing model of equation (2), or some other well-known pricing model) which has been modified to take into account both past and predicted future average credit spread changes, is applied. The present invention contemplates four average credit spread-related modifications to the Black-Scholes pricing model of equation (2) (such modifications can also be applied to other pricing models). First, the strike price, K, is the forecasted (i.e., predicted future) average credit spread condition.

Second, because we are dealing with average credit spreads and not an underlying stock with a quoted (i.e., market) price, the underlying commodity price, S, is the historical average credit spread value for the market segment(s) defined by geography, credit history, industry type, industry size, firm size, provision of collateral, third-party guarantee, or type of debt obligation for the time period between the start and maturity dates.

Third, the volatility σ, using the historical method, is the annualized standard deviation of the natural logarithm (ln) of the average credit spread as called for in the contract. In a preferred embodiment of the present invention where the average credit spread history database 108 includes data for twenty years, the volatility will be an annualized standard deviation of the measure of the average credit spread over the past twenty years.

Fourth, as a consequence of the modifications mentioned above, the standard normal distribution function calculation of equations (4) and (5) is also modified. To account for average credit spreads, N(d₁) is first calculated and then N(d₂) is set to the same value. This is done because many pricing models, including the Black-Scholes pricing model, are designed for commodities that fluctuate in price on a given day. That price may vary from minute to minute during active trading on an exchange (e.g., NYSE) and would be important in the valuation of an option for that commodity. However, because the present invention deals with average credit spreads as the underlying commodity, the selected average credit spread conditions fluctuations for a given day are not as relevant considering average credit spread-linked or average credit spread-impacted financial instruments deal with average credit spread movements.

In equations (7) and (8) below, the sum n+1 represents the number of historical average credit spread observations calculated from querying the average credit spread history database 108. Thus, uᵢ is defined as the logarithm of the price S relative between two average credit spread “prices” (i.e., historical average credit spread measurements) Sᵢ and Sᵢ₋₁ and is expressed by equation (7):
uᵢ=ln(sᵢ/sᵢ₊₁) (7)

Thus, historical volatility, σ, can be calculated using equation (8):

$${σ}^{2} = {\sum }^{n} {( {u}_{i} - u )}^{2} \\ i = 1 \qquad ( 8 )$$

In equation (8), u is the mean of all average credit spread observations. Finally, σ may then be computed by taking the square root of σ².

In step 418, trading system 100 may now output the “predicted future price of average credit spread financial instruments” (i.e., C for a call-type average credit spread option) for the average credit spread financial transaction. That is, trading system 100 may publish a call option contract price for a particular period (i.e., between the start date and maturity date), for a particular market segment, for a particular average credit spread. The operation of trading system 100 is thus complete as indicated by step 420 of flowchart 400.

In an alternative embodiment, as will be apparent to one skilled in the relevant art(s) based on the teachings contained herein, trading server 102 of trading system 100 may operate in a manner where the volatility σ is outputted when given the cost of an average credit spread financial instrument contract C. Furthermore, the present invention contemplates an embodiment where, standard inputs are entered into trading system 100 for given market segments (defined by geography, credit history, industry type, industry size, firm size, provision of collateral, third-party guarantee, or type of debt obligation) so that the relevant “Average credit spread” value, in quote form or not in quote form, may be published in the information distribution medium 116. That is, an “Average Credit Spread” value may be published in an information distribution medium 116 or other similar tools for a plurality of market segments given an agreed upon set of inputs for an average credit spread financial instrument or instruments. For example, the output of step 418 may be an “Average Credit Spread Summary” (similar to the Dow™ Industrials or S&P™ 500) for future months for a particular market segment.

V. Detailed Example of System Operation

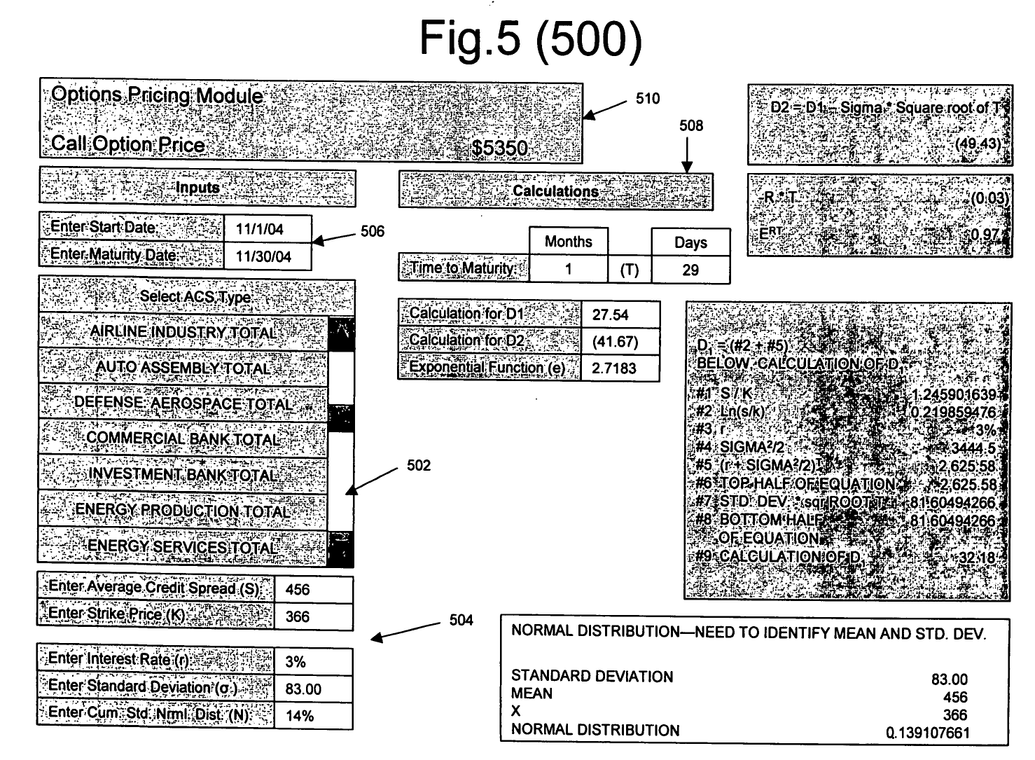

In an embodiment of the present invention, trading server 102 will provide a GUI (as shown in FIG. 5) for users, such as the in-house traders using the plurality of workstations 110, to enter inputs and receive the outputs as described in flowchart 400. Further, trading server 102 in conjunction with the web server 110 will also provide a GUI to the plurality of external users on the workstations 114 to enter inputs and receive the outputs as described in flowchart 400.

Still referring to FIG. 5, a detailed example of the operation of trading system 100 is presented in Table 2 below. Table 2 illustrates example numbers for each step of flowchart 400 presented in FIG. 4. In this example, as will be apparent to one skilled in the relevant art(s) based on the teachings contained herein, trading server 102 will use the average credit spread data stored in databases 106 and 108 in calculating the relevant changes to average credit spread financial instruments for steps 412 and 414, respectively.

A GUI screen 500 with the representative numbers in Table 2 is shown in FIG. 5. The GUI screen 500 includes a pull-down menu 502 listing each market segment for which the average credit spread history database 108 and predicted future average credit spread database 106 have available data and thus, trading system 100 may process a financial transaction for.

TABLE 2

| Step | Input(s)/Calculation(s) | Equation(s) |
|---|---|---|
| 404 | Start Date = Nov. 1, 1998 | |
| 406 | Maturity Date = Nov. 30, 1998 | |
| 408 | Average Credit Spread = “AIRLINE | |
| | INDUSTRY TOTAL” | |
| 409 | Currency = USD | |
| 410 | Interest Rate = 3% | |
| 412 | Latest Spread Value = 456 | (2) |
| 414 | Strike Price = 366 | (2) |
| 416 | S = 456 | (2) |
| | K = 366 | (2) |
| | t = 29 days = 29/30 months = 0.9667 | |
| | r = 3% | |
| | e = 2.71828 | |
| | σ = 83 | (7) & (8) |
| | d₁ = [ln(S/K) + (r + σ²/2)^{t}]/σ√t | (3A) |
| | d₁ = 32.18 | |
| | d₂ = d₁ − σ√t = −49.43 | (3B) |
| | N(d₁) = 14% | (4) & (5) |
| | N(d₂) = 14% | |
| 418 | C = S * N(d₁) − Ke^{-(rt)} * N(d₂) = $4,486 | (2) |

The GUI screen 500 further includes a display 504 indicating the latest spread value and strike price for the market segment(s) defined by geography, credit history, industry type, industry size, firm size, provision of collateral, third-party guarantee, or type of debt obligation. These values are highlighted in the pull down menu 502. The average credit spread information shown in display 504 is calculated from the average credit spread history database 108 and predicted future average credit spread database 106, respectively, after the user has used input boxes 506 to enter the contact start and maturity dates, respectively. GUI Screen 500 also includes calculation boxes 508 which show the various components of equation (3A) and equation (3B). Upon trading system 100 calculating equation (3A) and equation (3B), the call option price is displayed in a box 510 within the GUI screen 500.

VI. Environment

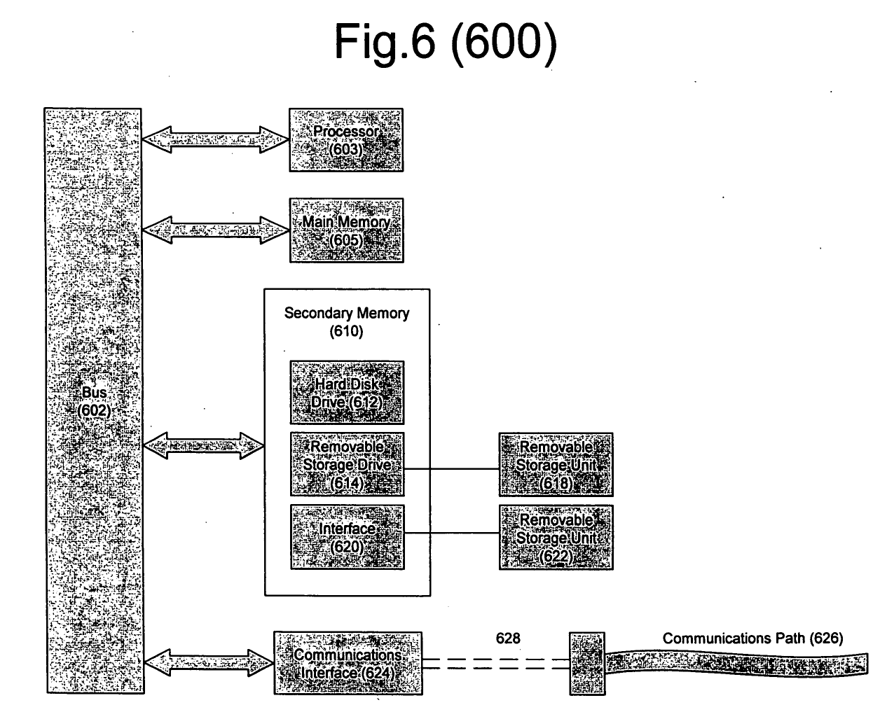

The present invention (i.e., trading system 100 or any part thereof) may be implemented using hardware, software or a combination thereof and may be implemented in one or more computer systems or other processing systems. In fact, in one embodiment, the invention is directed toward one or more computer systems capable of carrying out the functionality described herein. An example of a computer system 600 is shown in FIG. 6. The computer system 600 includes one or more processors, such as processor 603. The processor 603 is connected to a communication bus 602. Various software embodiments are described in terms of this exemplary computer system. After reading this description, it will be apparent to a person skilled in the relevant art how to implement the invention using other computer systems and/or computer architectures.

Computer system 600 also includes a main memory 605, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, etc. The removable storage drive 614 reads from and/or writes to a removable storage unit 618 in a well known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a PCMCIA slot and card, etc. Software and data transferred via communications interface 624 are in the form of signals 628 which may be electronic, electromagnetic, optical or other signals capable of being received by communications interface 624. These signals 628 are provided to communications interface 624 via a communications path (i.e., channel) 626. This channel 626 carries signals 628 and may be implemented using wire or cable, fiber optics, a phone line, a cellular phone link, an RF link and other communications channels.

In this document, the term “computer program product” refers to removable storage units 618, 622, and signals 628. These computer program products are means for providing software to computer system 600. The invention is directed to such computer program products.

Computer programs (also called computer control logic) are stored in main memory 605, and/or secondary memory 610 and/or in computer program products. Computer programs may also be received via communications interface 624. Such computer programs, when executed, enable the computer system 600 to perform the features of the present invention as discussed herein. In particular, the computer programs, when executed, enable the processor 603 to perform the features of the present invention. Accordingly, such computer programs represent controllers of the computer system 600.

In an embodiment where the invention is implemented using software, the software may be stored in a computer program product and loaded into computer system 600 using at least one removable storage drive 614, hard drive 612 or communications interface 624. The control logic (software), when executed by the processor 603, causes the processor 603 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While preferred embodiments of the invention have been described and illustrated, it should be apparent that many modifications to the embodiments and implementations of the invention can be made without departing from the spirit or scope of the invention. For example, while only vanilla American options are explained in detail in the interest of simplicity, the same general approach can be applied to computing volatilities implied by exotic American options and/or American options with transaction costs and/or other varieties of options, as well as the inverse pricing of other financial instruments not described herein, such as, but not limited to, futures, forwards, swaps, swaptions, caps, floors, collars, corridors, notes, etc. The modules illustrated in FIG. 1 as making up trading system 100 may be one or more hardware, software, or hybrid components residing in (or distributed among) one or more local or remote computer systems. Although the modules are shown as physically separated components, it should be readily apparent that the modules may be combined or further separated into a variety of different components, sharing different resources (including processing units, memory, clock devices, software routines, etc.) as required for the particular implementation of the embodiment. Indeed, even a single general purpose computer executing a computer program to produce the functionality described herein may be utilized to implement the illustrated embodiments. A user interface device may be implemented to input and/or output information during an exchange of information between user and trading system 100. The user interface device may be implemented as a graphical user interface (GUI) containing a display or the like, or may be a link to other user input/output devices known in the art. The depiction of external users 114a to 114n is made to represent a variety of known users and the supporting systems that provide user access, such as networks and connected systems, i.e. local or wide area networks, a company intranet, systems providing Internet access, electronic communications network (ECNs), small order exchange systems (SOES), on-line brokers or other trading networks, or other such communications tools.

While various embodiments of the present invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus, the present invention should not be limited by any of the above-described exemplary embodiments, but should be defined only in accordance with the present invention's claims and their equivalents.

What is claimed is:

1. A method for creating and valuing financial instruments based upon average credit spreads which compile average credit spread information in market segments defined by geography, credit history, industry type, industry size, firm size, provision of collateral, third-party guarantee, or type of debt obligation.

2. The method of claim 1, where the future value of said financial instrument is calculated by inputting historical average credit spread information and/or predicted future average credit spread information and/or financial information, interest rate(s), currency denomination(s), and start date and date of expiry of each contract into a pricing model including but not limited to trinomial, binomial, Monte Carlo simulation, or Black-Scholes model.

3. The method of claim 2, wherein said financial instrument may be comprised of multiple financial instruments involving at least one financial instrument based upon an average credit spread, or is based upon multiple average credit spreads for different market segments, including but not limited to asset-backed securities, basket options, chooser options, option chains, or rainbow options.

4. A method for disseminating information for a financial instrument related to at least one average credit spread, comprising the steps of:
a. quoting prices, historical average credit spread information and/or predicted future average credit spread information and/or metrics (ex. prices, open interest, 90-day volatility) on contracts of an average credit spread linked financial instrument.
b. using an information distribution medium, either physical or electronic, to disseminate said information of claim a. to users of this information.

5. A computer-implemented method for creating and valuing a financial instrument based upon average credit spreads which compile credit spread information in market segments defined by geography, credit history, industry type, industry size, firm size, provision of collateral, third-party guarantee, or type of debt obligation.

6. The method of claim 5, where the future value of said financial instrument is calculated by inputting historical average credit spread information and/or predicted future average credit spread information and/or financial information, interest rate(s), currency denomination(s), and start date and date of expiry of each contract into a pricing model including but not limited to trinomial, binomial, Monte Carlo simulation, or Black-Scholes model.

7. The method of claim 6, wherein said financial instrument may be comprised of multiple financial instruments involving at least one financial instrument based upon an average credit spread, or is based upon multiple average credit spreads for different market segments, including but not limited to asset-backed securities, basket options, chooser options, option chains, or rainbow options.

8. A computer-implemented method for determining the volatility of financial instruments based upon average credit spreads which compile credit spread information in market segments defined by geography, credit history, industry type, industry size, firm size, provision of collateral, third-party guarantee, or type of debt obligation.

9. The method of claim 8, where the volatility of said financial instrument is calculated by inputting historical average credit spread information and/or predicted future average credit spread information and/or financial information, interest rate(s), currency denomination(s), and start date and date of expiry of each contract into a pricing model including but not limited to trinomial, binomial, Monte Carlo simulation, or Black-Scholes model.

10. The method of claim 9, wherein said financial instrument may be comprised of multiple financial instruments involving at least one financial instrument based upon an average credit spread, or is based upon multiple average credit spreads for different market segments, including but not limited to asset-backed securities, basket options, chooser options, option chains, or rainbow options.

11. A computer system for creating and valuing a financial instrument based upon average credit spreads which compile credit spread information in market segments defined by geography, credit history, industry type, industry size, firm size, provision of collateral, third-party guarantee, or type of debt obligation., comprising:
a. a computer connected to an average credit spread history database and/or a predicted future average credit spread database and/or financial database that creates and values a financial instrument under conditions where the future value of said financial instrument is calculated by inputting historical average credit spread information and/or predicted future average credit spread information and/or financial information, interest rate(s), currency denomination(s), and start date and date of expiry of each contract into a pricing model including but not limited to trinomial, binomial. Monte Carlo simulation, or Black-Scholes model.
b. at least one workstation that allows a user to specify inputs that affect the value of the average credit spread financial instrument.

12. A computer program product comprising a computer-usable medium having control logic stored therein for causing a computer to perform valuation of average credit spread linked financial instruments, said control logic comprising:
a. a computer readable program code means that causes the computer to create and value a financial instrument based upon average credit spreads which compile credit spread information in market segments defined by geography, credit history, industry type, industry size, firm size, provision of collateral, third-party guarantee, or type of debt obligation.
b. a computer readable program code means for valuing a financial instrument based upon average credit spreads by inputting historical average credit spread information and/or predicted future average credit spread information and/or financial information, interest rate(s), currency denomination(s), start date and date of expiry of each contract, and/or cost of the financial instrument into a pricing model including but not limited to trinomial, binomial, Monte Carlo simulation, or Black-Scholes model.
c. the method of claim b., where the future value of said financial instrument is a defined currency amount and the initial value is calculated by utilizing computer readable program code for applying a pricing model using historical average credit spread information and/or predicted future average credit spread information and/or financial information, interest rate(s), currency denomination(s), and start date and date of expiry of each contract.
